(19) United States
(12) Patent Application Publication
(10) Pub. No.: US 2003/0101190 A1
(43) Pub. Date: May 29, 2003

(54) Schema-based notification service

(75) Inventors: Eric J. Horvitz, Kirkland, WA (US); Paul A. Steckler, Redmond, WA (US); Shaun D. Pierce, Sammamish, WA (US); Lijiang Fang, Sammamish, WA (US); Mark H. Lucovsky, Sammamish, WA (US); Winnie C. Wu, Bellevue, WA (US)

Correspondence Address: Law Offices of Albert S. Michalik, PLLC, Suite 193, 704 -228th Avenue NE, Sammamish, WA, 98074, US

(73) Assignee: MICROSOFT CORPORATION, REDMOND, WA (US)

(21) Appl. No.: 10/187,196

(22) Filed: Jun. 28, 2002

Related U.S. Application Data
(63) Continuation-in-part of application No. 10/099,467, filed on Mar. 14, 2002.
Application No. 10/099,467 is a continuation-in-part of application No. 10/017,680, filed on Oct. 22, 2001.
(60) Provisional application No. 60/275,809, filed on Mar. 14, 2001.

(51) Int. Cl. G06F 7/00

(52) U.S. Cl. 707/100

(57) ABSTRACT

A schema-based notification/alert service for providing schema-based notifications. The notification service includes a schema that defines rules and a structure for sending, handling and/or receiving notifications and alerts. Senders and receivers manipulate (e.g., read or write) data in the logical document by data access requests through defined methods. In one implementation, the notification schemas are arranged as XML documents, and the services provide methods that control access to the data based on the requesting user's identification, defined role and scope for that role. Extensibility is defined into the schema. An architecture is provided to intelligently route alerts from senders to client user agent recipients.

### CROSS REFERENCE TO RELATED APPLICATIONS

The present application is a continuation-in-part of U.S. patent application Ser. No. 10/099,467, filed Mar. 14, 2002, which is a continuation-in-part of co-pending U.S. patent application Ser. No. 10/017,680, filed Oct. 22, 2002, which claims priority to U.S. provisional application serial No. 60/275,809, filed Mar. 14, 2001, which are hereby incorporated herein by reference in their entireties.

### COPYRIGHT DISCLAIMER

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to computer network data access, and more particularly to systems, methods and data structures for accessing data and data-related services over a network.

### BACKGROUND OF THE INVENTION

There are many types of data that users need to manage and otherwise access. For example, users keep word processing documents, spreadsheet documents, calendars, telephone numbers and addresses, e-mail messages, financial information and so on. In general, users maintain this information on various personal computers, hand-held computers, pocket-sized computers, personal digital assistants, mobile phones and other electronic devices. In most cases, a user's data on one device is not accessible to another device, without some manual synchronization process or the like to exchange the data, which is cumbersome. Moreover, some devices do not readily allow for synchronization. For example, if a user leaves his cell phone at work, he has no way to get his stored phone numbers off the cell phone when at home, even if the user has a computing device or similar cell phone at his disposal. As is evident, these drawbacks result from the separate devices each containing their own data.

Corporate networks and the like can provide users with remote access to some of their data, but many users do not have access to such a network. For many of those that have access, connecting to a network with the many different types of devices, assuming such devices can even connect to a network, can be a complex or overwhelming problem.

Moreover, even if a user has centrally stored data, the user needs the correct type of device running the appropriate application program to access that data. For example, a user with a PDA that maintains a user's schedule (e.g., appointments, meetings and so on) with a simple to-do list application program ordinarily will not be able to use that program to open a calendar stored by an email application program or the like at work. In general, this is because the data is formatted and accessed according to the way the application program wants it to be formatted.

What is needed is a model wherein data is centrally stored for users, with a set of services that control access to the data with defined methods, regardless of the application program and/or device.

### SUMMARY OF THE INVENTION

Briefly, the present invention provides a Notification (or Alerts) service for central (e.g., Internet) access to and provision of per-user notification/alert data, based on each user's identity, wherein the notification service includes a schema that defines rules and a structure for the data, and also includes methods that provide access to the data in a defined way. Because the structure of the data is defined from the perspective of the data, not from that of an application program or a device, programs can communicate with the services to access the data, with existing knowledge of the format, in order to receive notifications also formatted/regularized according to a defined schema. In one implementation, the Notification schemas are arranged as XML documents, and the services provide methods that control access to the data based on the requesting user's identification, defined role and scope for that role. In this way, data can be accessed by its owner, and shared to an extent determined by the owner. Extensibility is defined into the schema.

Other benefits and advantages will become apparent from the following detailed description when taken in conjunction with the drawings, in which:

### BRIEF DESCRIPTION OF THE DRAWINGS

FIG. 1 is a block diagram representing an exemplary computer system into which the present invention may be incorporated;

FIG. 2 is a block diagram representing a generic data access model in accordance with one aspect of the present invention;

FIG. 3 is a representation of services for identity-based data access in accordance with one aspect of the present invention;

FIG. 4 is a block diagram representing a schema-based service for accessing data arranged in a logical content document based on a defined schema for that service in accordance with one aspect of the present invention; and

FIG. 5 is a block diagram generally representing an arrangement of an alerts service in accordance with one aspect of the present invention.

### DETAILED DESCRIPTION

Exemplary Operating Environment

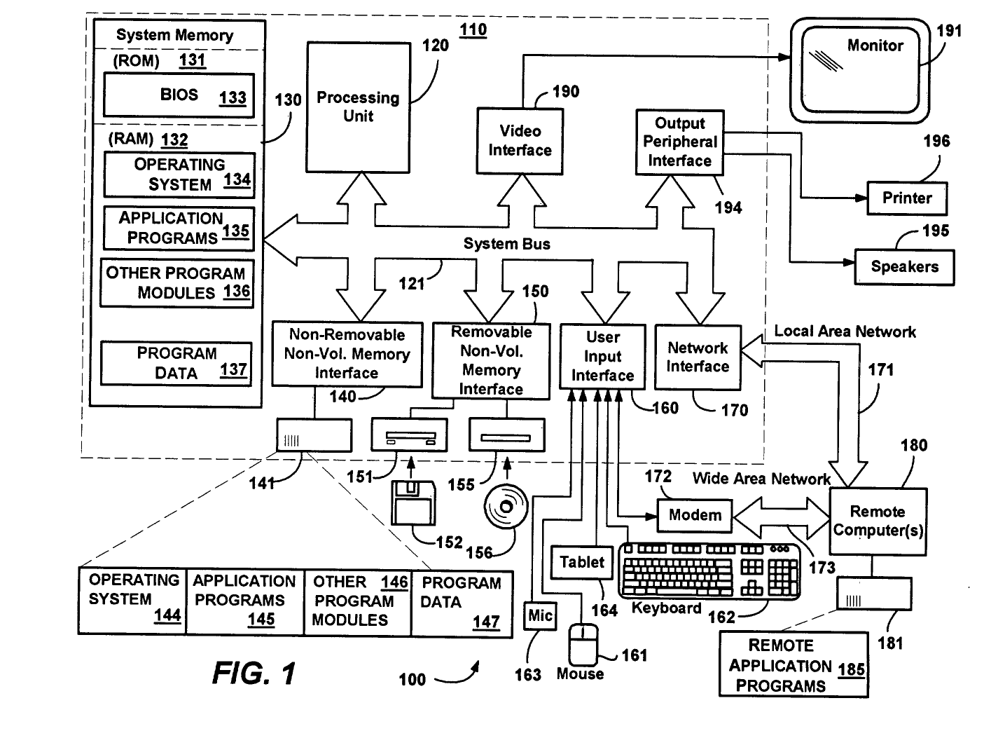

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 1 10. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Data Access Model

The present invention generally operates in an architecture/platform that connects network-based (e.g., Internet-based) applications, devices and services, and transforms them into a user's personal network which works on the user's behalf, and with permissions granted by the user. To this end, the present invention is generally directed to schema-based services that maintain user, group, corporate or other entity data in a commonly accessible virtual location, such as the Internet. The present invention is intended to scale to millions of users, and be stored reliably, and thus it is likely that a user's data will be distributed among and/or replicated to numerous storage devices, such as controlled via a server federation. As such, while the present invention will be generally described with respect to an identity-centric model that enables a user with an appropriate identity and credentials to access data by communicating with various core or other services, it is understood that the schema-based services described herein are arranged for handling the data of millions of users, sorted on a per-user-identity basis. Note that while “user” is generally employed herein for simplicity, as used herein the term “user” is really a substitute for any identity, which may be a user, a group, another entity, an event, a project, and so on.

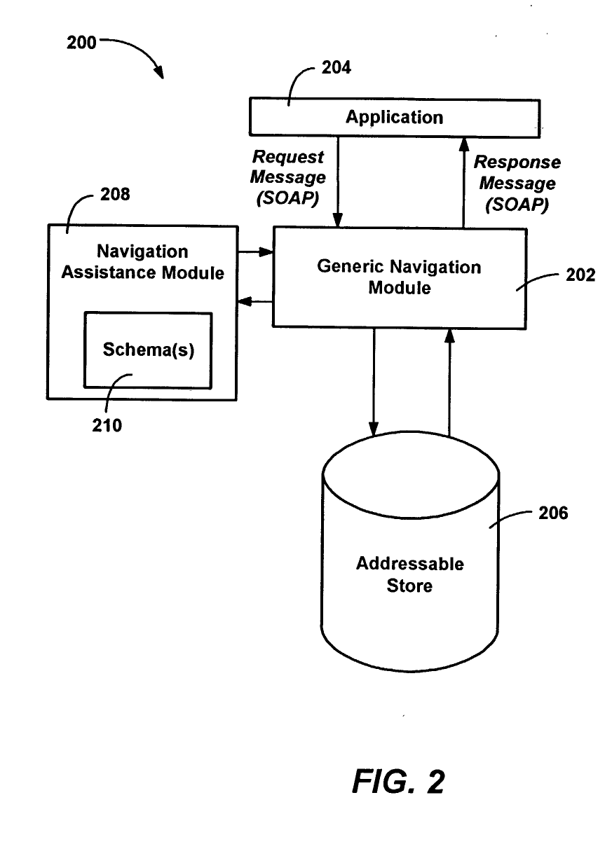

As generally represented in FIG. 2, a data access model 200 includes a generic navigation module 202 through which applications 204 and the like may access a wide variety of identity-based data, such as maintained in an addressable store 206. To access the data, a common set of command methods may be used to perform operations on various data structures that are constructed from the data in the addressable store 206, even though each of those data structures may represent different data and be organized quite differently. Such command methods may describe generic operations that may be desired on a wide variety of data structures, and include, for example, insert, delete, replace, update, query or changequery methods.

In accordance with one aspect of the present invention and as described in detail below, the data is accessed according to various schemas, with the schemas corresponding to identity-based services through which users access their data. As used herein, a “schema” generally comprises a set of rules that define how a data structure may be organized, e.g., what elements are supported, in what order they appear, how many times they appear, and so on. In addition, a schema may define, via color-coding or other identification mechanisms, what portions of an XML document (that corresponds to the data structure) may be operated on. Examples of such XML-based documents are described below. The schema may also define how the structure of the XML document may be extended to include elements not expressly mentioned in the schema.

As will be understood below, the schemas vary depending on the type of data they are intended to organize, e.g., an email-inbox-related schema organizes data differently from a schema that organizes a user's favorite websites. Further, the services that employ schemas may vary. As such, the generic navigation module 202 has associated therewith a navigation assistance module 208 that includes or is otherwise associated with one or more schemas 210. As will be understood, a navigation assistance module 208 as represented in FIG. 2 corresponds to one or more services, and possesses the information that defines how to navigate through the various data structures, and may also indicate which command methods may be executed on what portions of the data structure. Although in FIG. 2 only one navigation assistance module 208 is shown coupled to the generic navigation module 202, there may be multiple navigation assistance modules that may each specialize as desired. For example, each navigation assistance module may correspond to one service. Moreover, although the navigation assistance module 208 is illustrated as a separate module, some or all of the operations of the navigation assistance module 208 may be incorporated into the generic navigation module 202, and vice versa. In one embodiment, the various data structures constructed from the schema and addressable store data may comprise XML documents of various XML classes. In that case, the navigation assistance module 208 may contain a schema associated with each of the classes of XML documents.

The present invention provides a number of schema-based services that facilitate data access based on the identity of a user. Preferably, the user need not obtain a separate identity for each service, but rather obtains a single identity via a single set of credentials, such as with the Microsoft® Passport online service. With such an identity, a user can access data via these services from virtually any network connectable device capable of running an application that can call the methods of a service.

Services and Schemas

“.NET My Services” comprises identity-centric services which may be generally implemented in XML (extensible Markup Language) Message Interfaces (XMIs). While the present invention will be described with respect to XML and XMI, it can readily be appreciated that the present invention is not limited to any particular language or set of interfaces. The .NET My Services model essentially corresponds to one implementation of the generic data access model 200 of FIG. 2.

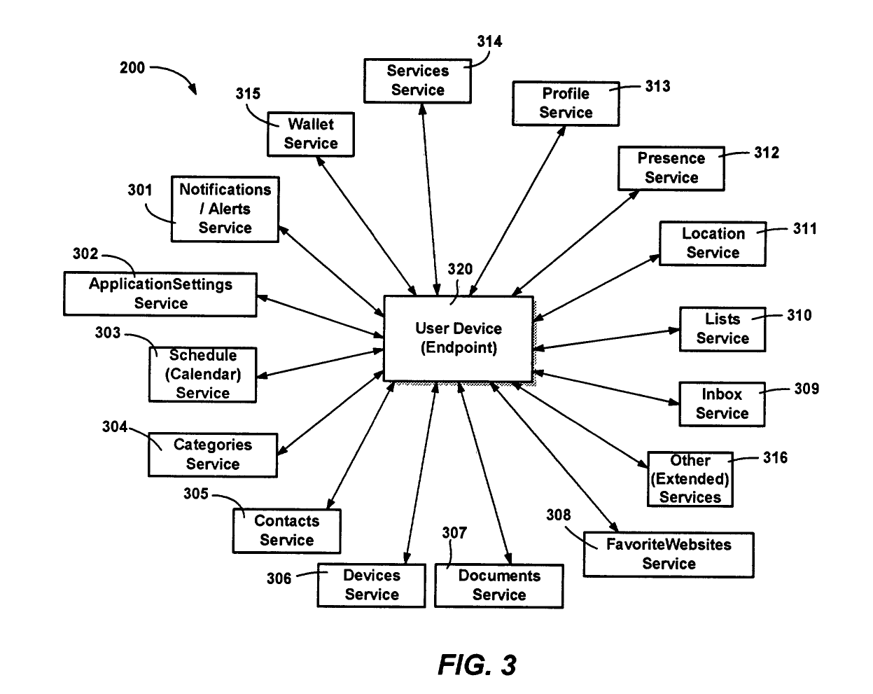

As generally represented in FIG. 3, NET My Services 300 is implemented as a set of Web services 301-316, each bound to a .NET Identity (PUID, such as a Passport® unique identifier similar to a globally unique identifier when Passport® is the authentication service). The services 301-316 can communicate with one another via a service-to-service communications protocol (SSCP), described below. As also described below, each service presents itself as a set of XML documents that can be manipulated from an application program 202 (FIG. 2) or the like using a set of standard methods and domain-specific methods. To this end, a user device 320 (endpoint) running such application programs connects a user's applications to the services, and the data controlled by those services, such as over the Internet or an Intranet, such as over the Internet or an Intranet. Note that endpoints can be client devices, applications or services. In keeping with the present invention, virtually any device capable of executing software and connecting to a network in any means may thus give a user access to data that the user is allowed to access, such as the user's own data, or data that a friend or colleague has specified as being accessible to that particular user.

In general, a NET Identity is an identifier assigned to an individual, a group of individuals, or some form of organization or project. Using this identifier, services bound to that identity can be located and manipulated. A general effect is that each identity (e.g., of a user, group or organization) has tied to it a set of services that are partitioned along schema boundaries and across different identities. As will be understood, the XML-document-centric architecture of NET My Services provides a model for manipulating and communicating service state that is very different from prior data access models. The XML-document-centric approach, in conjunction with loose binding to the data exposed by the services, enables new classes of application programs. As will also be understood, the .NET My Services model 300 presents the various services 301-316 using a uniform and consistent service and method model, a uniform and consistent data access and manipulation model, and a uniform and consistent security authorization model.

In a preferred implementation, the .NET My Services model 300 is based upon open Internet standards. Services are accessed by means of SOAP (Simple Object Access Protocol) messages containing an XML payload. Service input and output is expressed as AL document outlines, and each of these document outlines conform to an XML schema document. The content is available to a user interacting with the NET My Services service endpoint 320.

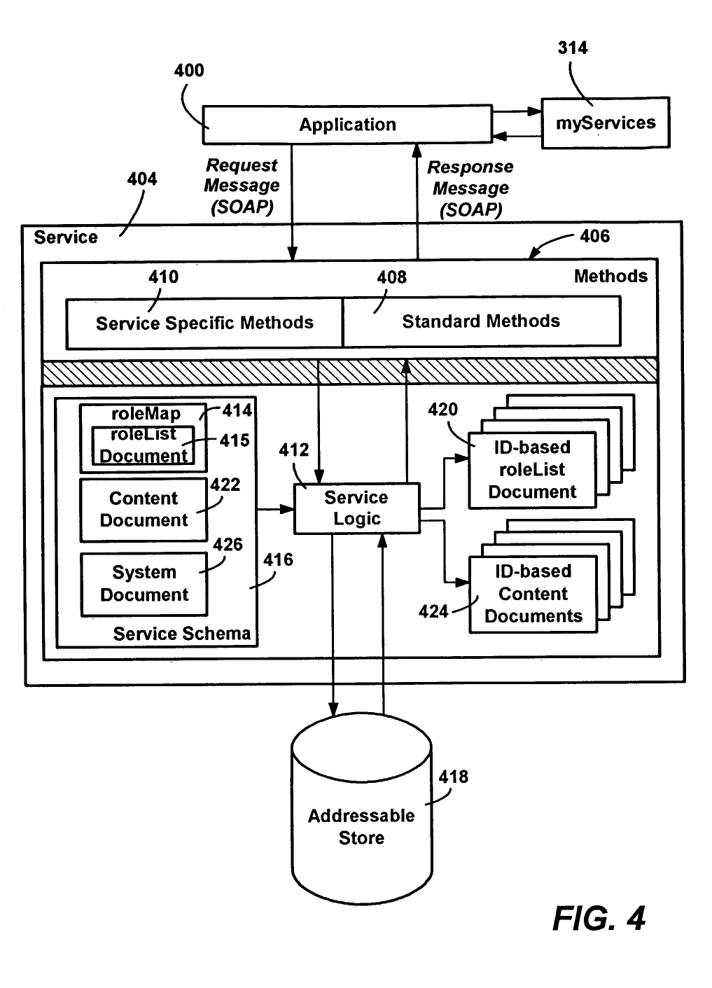

Turning to FIG. 4, in the NET My Services model, an application 400 requests performance of a method that operates on data structures. The application may make a request that is generic with respect to the type of data structure being operated upon and without requiring dedicated executable code for manipulating data structures of any particular data type. To this end, in one implementation the application first contacts a special myServices service 314 to obtain the information needed to communicate with a particular service 404, through a set of methods 406 of that service 404. For example, the needed information received from the myServices service 314 includes a URI of that service 404. Note that the service 404 may correspond to essentially any of the services represented in FIG. 3, such as the myNotification service 301.

In an alternate implementation, the services and data may be available on an intranet or the like. In such an event, it may be unnecessary to use the myServices service 314, e.g., if the URI of the desired services are fixed for any user of the intranet. Notwithstanding, a more flexible approach with an intranet may be to have the myServices service that simply provides an intranet URI, such as from a simple lookup table, whereby an administrator and the applications would not be bound to anything fixed.

The service 404 includes or is otherwise associated with a set of methods 406 including standard methods 408, such as to handle requests directed to insert, delete, replace, update, query or changequery operations on the data. The set of methods of a particular service may also include service specific methods 410. In general, the only way in which an application can communicate with a service are via that service's methods.

Each service includes service logic 412 for handling requests and providing suitable responses. To this end, the service logic performs various functions such as authorization, authentication, and signature validation, and further limits valid users to only the data which they are permitted to access. The security aspect of a service is not discussed herein, except to note that in general, for otherwise valid users, the user's identity determines whether a user can access data in a requested manner. To this end, a roleMap 414 comprising service-wide roleList document templates 415 and scopes (e.g., part of the overall service's schema 416), in conjunction with-user-based data maintained in an addressable store 418, determines whether a particular requested method is allowed, e.g., by forming an identity-based roleList document 420. If a method is allowed, the scope information in the roleMap 414 determines a shape of data to return, e.g., how much content is allowed to be accessed for this particular user for this particular request. The content is obtained in accordance with a content document 422 in the service's schema 416 and the actual user data corresponding to that content document in the addressable store 418. In this manner, a per-identity shaped content document 424 is essentially constructed for returning to the user, or for updating the addressable store, as appropriate for the method. Note that FIG. 4 includes a number of ID-based roleList documents and ID-based content documents, to emphasize that the service 406 is arranged to serve multiple users. Also, in FIG. 4, a system document 426 is present as part of the schema 416, as described below.

Returning to FIG. 3, in one implementation, access to NET My Services 300 is accomplished using SOAP messages formatted with NET My Services-specific header and body content. Each of the NET My Services will accept these messages by means of an HTTP POST operation, and generate a response by “piggy-backing” on the HTTP Response, or by issuing an HTTP POST to a .NET My Services response-processing endpoint 320. In addition to HTTP as the message transfer protocol, NET My Services will support raw SOAP over TCP, a transfer protocol known as Direct Internet Message Encapsulation (or DIME). Other protocols for transferring messages are feasible.

Because .NET My Services are accessed by protocol, no particular client-side binding code, object models, API layers, or equivalents are required, and are thus optional. The NET My Services will support Web Services Description Language (WSDL). It is not mandatory that applications wishing to interact with .NET My Services make use of any particular bindings, and such bindings are not described herein. Instead, the present invention will be generally described in terms of messages that flow between requestors of a particular service and the service endpoints. In order to interact with NET My Services, a service needs to format a NET My Services message and deliver that message to a .NET My Services endpoint. In order to format a message, a client needs to manipulate XML document outlines, and typically perform some simple, known (public-domain) cryptographic operations on portions of the message.

In accordance with one aspect of the present invention, and as described in FIG. 4 and below, in one preferred implementation, services (including the myNotification service 301) present three logical XML documents, a content document 422, roleList document 415 (of the roleMap 414), and a system document 426. These documents are addressable using .NET My Services message headers, and are manipulated using standard NET My Services methods. In addition to these common methods, each service may include additional domain-specific methods, such as updateNotificationData.

Each NET MyServices service thus logically includes a content document 422, which in general is the main, service-specific document. The schema for this document 422 is a function of the class of service, as will become apparent from the description of the myNotification service's content document below. For example, in the case of the myNotification service 301, the content document presents data in the shape dictated by the .NET My Services MyNotification schema, whereas in the case of the “.NET FavoriteWebSites” service 308, the content document presents data in the shape dictated by a .NET myFavoriteWebSites schema.

Each service also includes a roleList document 415 that contains roleList information, comprising information that governs access to the data and methods exported by the service 404. The roleList document is manipulated using the .NET My Services standard data manipulation mechanisms. The shape of this document is governed by the NET My Services core schema's roleListType XML data type.

Each service also includes a system document 426, which contains service-specific system data such as the roleMap, schemaMap, messageMap, version information, and service specific global data. The document is manipulated using the standard NET data manipulation mechanism, although modifications are limited in a way that allows only the service itself to modify the document. The shape of this system document 426 may be governed by the system document schema for the particular service, in that each service may extend a base system document type with service specific information.

As is understood, the present invention is generally based on schemas, which in general comprise a set of rules or standards that define how a particular type of data can be structured. Via the schemas, the meaning of data, rather than just the data itself, may be communicated between computer systems. For example, a computer device may recognize that a data structure that follows a particular address schema represents an address, enabling the computer to “understand” the component part of an address. The computer device may then perform intelligent actions based on the understanding that the data structure represents an address. Such actions may include, for example, the presentation of an action menu to the user that represents things to do with addresses. Schemas may be stored locally on a device and/or globally in a federation's “mega-store.” A device can keep a locally-stored schema updated by subscribing to an event notification service (in this case, a schema update service) that automatically passes messages to the device when the schema is updated. Access to globally stored schemas is controlled by the security infrastructure.

General Schema Commonality

The .NET My Services data is defined using annotated XSD schema files. The XSD files accurately type the data, but since XSD is a verbose and complex language, it is not a particularly efficient way to convey structure and meaning. Thus, for purposes of simplicity herein, the myNotification schemas are described below in terms of schema outlines with accompanying element/attribute descriptions. These document outlines accurately show the structure of the data contained within a service. However, because the present application is not viewable in color, the nodes, elements and/or attributes of the schema outlines (which may be described as bold blue, or blue), are represented in the schema outlines as boldface type. Those described as underlined red, or red, are represented as underlined type, while others referred to as black are represented in normal type.

The meaning of these bold (blue), underlined (red) and normal (black) items has significance with respect to the data model and to the data language that accesses and manipulates the data (e.g., via the insert, delete, replace, update, query, changequery or other methods). For example, each document described below contains a root element having an element name that matches that of the service, e.g., the myNotification service has a root element named myNotification. The .NET My Services name for this item is the root.

Documents contain elements that resemble first-class top-level objects, including, for example, <catDef/>, <myApplicationsSettings/>(other another name as appropriate) and <order/>. Such items are denoted in the outlines as bold (blue), and may be identified using an <xdb:blue/>tag. Bold (blue) items define major blocks of data within a service. These node sets are directly addressable by an identifier attribute, and their change status is tracked through a changeNumber attribute. Top-level bold blue items may be considered objects. As seen below, some bold (blue) objects contain nested bold blue objects. They usually contain frequently changing underlined (red) properties, which reduces the amount of synchronization traffic. Nested bold (blue) items may be considered property groups.

Each bold blue item contains one or more underlined (red) items which are elements or attributes. These items may be identified using the <xdb:red/>tag. These items are special in that they may be used within predicates (filters) to aid in xdb:bold blue selection. These items are also directly addressable and may be manipulated directly by the data manipulation language.

Each underlined (colored red) element may contain one or more non-colorized elements and attributes, which are valid and semantically meaningful XML items in the service document. Such items are opaque to the data language. These uncolored (i.e., non-bold or underlined) elements and attributes may not be addressed directly, may not be selected in a node selection operation, and may not be used in a predicate node test. Note that if one of these items is in the path to an underlined red item, it may be used in a location step to the underlined red item, but may not be used as the selected node. Note that being opaque does not mean that the item is not considered during schema validation, but rather means that the item may not be used in a predicate, may not be directly addressed, and may not be inserted by itself. As can be readily appreciated, in this manner, the NET My Services thus limits the granularity of access to nodes within the service document, since only xdb:bold blue and xdb:underlined red marked items are directly addressable, and only those elements and attributes tagged with the xdb:underlined red annotation may be used in predicates to influence node selection. Using this technique, the NET My Services storage system can efficiently manage indexes, increase the performance of node selection, partially shred the document data, and in general (because the node selections are well defined) fine-tune the node selection logic on a per-xdb:blue basis. The primary purpose of the xdb:blue is to define a base-level XML object that is designed to be operated on as a unit. The primary purpose of the xdb:red items is to aid in the selection of xdb:bold blues. The xdb:red items may be changed by the data language primitives so some level of fine-grained manipulation of the data is available, but only in very limited ways.

Bold blue items have unique IDs, which are usually assigned by .NET My Services, and are returned from update operations within the new blueId node. In all cases, the order of xxxBold blue follows the pre-order traversal of the document XML tree. Item IDs are UUIDs in the following format (h stands for a hexadecimal digit): hhhhhhhh-hhhh-hhhh-hhhh-hhhhhhhhhhhh.

In addition to identifiers, names and change numbers, nodes and especially red nodes may include creator identifiers, category information, and {any} fields. Category information enables data to be grouped and/or distinguished in some way, such as to share certain calendar information with golf buddies, send an email to immediately family, designate things such as which telephone number is the user's primary number, e.g., if a user has a second home, and so on. Fields of type “any” may comprise fully-typed, namespace-qualified fields that contain any type of content (e.g., free-form XML) therein. Such “any” fields thus allow extensibility of the schema, yet maintain the defined structure of a schema.

In one implementation, the core data-manipulation language implemented by the .NET My Services includes an insertRequest, or insert message. This primitive inserts any schema-valid XML fragment into a selected context, thereby changing the existing state of the document. A queryRequest, or message, retrieves data, such as to retrieve a document. Multiple queries may be specified in one request, and queries that select nothing are considered successful. It is possible to assert that the number of nodes in the selection falls in a given range. This is expressed using minOccurs and maxOccurs attributes. If a minOccurs/maxOccurs test fails on any node, the request is considered unsuccessful. Note that this is different from a failure code, which would be returned, for example, for a malformed request.

A deleteRequest primitive deletes the selected nodes and all their children. Note that, just like for other requests, attributes may be selected as well as elements. Empty selections result in successful operations, similar to Query. The minOccurs/maxOccurs tests are supported wherever select is allowed.

A replaceRequest primitive (replace message) is designed to replace the content of each of the selected nodes with the specified new content. Selected nodes themselves are not affected in any way. This may be considered as an atomic delete of the content of the selected node, followed by an insert. The content (text, attributes, elements) in the selected nodes are replaced with the new item specified in this message. The node type of the selected node and of the replacement node are thus required to be the same. The changequery request essentially returns result comprising data that has changed.

As mentioned above, each of the services includes a RoleList document and scope information that describes which users have what type of access to which data. For example, a data owner will have read/write access to his or her own data, and can provide various types of rights to that data to other users based on their IDs, (e.g., read only to some users, read write to others). Each role list identifier may be associated with a scope, by which the kinds of data stored according to a given schema can be controlled per user. For example, a user can give a friend (with one identity) access via a service to a home telephone number, home address and so forth, but can give other users (with other identities) access only to a business telephone number. In general, a scope can be defined such that that it includes everything except any specifically listed items, or excludes everything except any specifically listed items.

.NET Notivications (myNotifications) and .NET Alerts (myAlerts) Service

In general, the present invention is related to a schema for providing data to one or more endpoint devices based on an identity of a recipient. The schema along with a method and system for using the schema may be arranged in any number of ways, including two implementations generally described herein, NET Notifications,(myNotifications) and NET Alerts (myAlerts). As will become apparent, however, the present invention is not limited to the two described implementations, nor is there any exclusivity between implementations. Indeed, a notifications/alerts service based on some combination of both implementations described herein would be straightforward to implement.

NET Notification (myNotification) Service

In accordance with an aspect of the present invention, notifications from various information sources are regularized via information encoded in a defined notification schema, such as the service schema 416 of FIG. 4. For example, notification information may be sent in an XML-formatted document fragment based on the schema. Note that as described in the aforementioned U.S. patent application serial No. 10/099,467, the information sources may be arranged with internal user preference filtering or the like, so as to only selectively send notifications to subscribers, and an information agent service may receive, filter and/or otherwise modify a notification before handling the notification, including sending the notification to a recipient endpoint device of a user/identity.

In general, a notification schema 416 represents metadata about the subscription of a service to a source of information, as well as representing details about that information, including the nature, importance, time criticality or urgency of information, disposition over time of information provided by a message, and message handling preferences. An example of how a notification schema may be arranged and the information that may be represented thereby is represented in the table below:

TABLE 1A
General Notification Schema

Header

Information identity: service, class, title (uuid), trackingID, author (incl. on behalf

```
info), author-type (person vs. agent)
Creation time
  Birth time: time indicated by author birth time for message, taken as the initial time, tₒ .
  Service receipt time: time received by notification service
Subscription path
```

Sources subscription operations path (details on subscribing and unsubscribing)
Source logo and graphics path (source logo and graphics information)
Source preference path
Administrative contact

Privacy and authorization

Authorizations for reading and writing to fields by proxies, people, groups

Transmission history (delays before transmission, prior attempts and times, where in
processing chain is message)
Reliability and confirmation

Confirmation requirement

Actions on failure type x

Journal on condition
Re-route on condition
Confirmation policy

Body
Content components

Content access

Embedded
Ptr (url)

Content properties

Text, properties
Graphics, properties
Audiovisual, properties
UI content and controls

Device preferences / hints
Bandwidth requirements

To/from device

Media rendering requirements

uri
Text, graphics (x,y), audio, etc.

User interaction requirements

Device genre

Small screen with functions {}
Rich client

User input capabilities

Special inputs
Text input- full keyboard, alternate
Cursor control
Speech
Audio
Videocapture

Client UI components

```
  Local UI code and interfaces
  e.g., Windows ® client modules, API
```

Backchannel and relay requirements

External messaging backchannel

Backchannel properties
Confirmation abilities

Local receipt
User confirmation

Device context status

e.g., In use, in motion, app status, activity status, last use

Local relay for platform services

APIs to local client services
Classes

Routing and alerting hints

Delivery Routing

Single Device
Device Set: { }
Device Sequence until confirmation: { }

Allow for conditioning on context and content

```
Condition 1
      Device x
Condition 2
      Device sequence: { }
Condition n
      Device Set: { }
```

Delivery Timing

Best Effort
Deliver by t

Action on Fail

Bounded deferral t

Conditions t:
Conditions flow <t: {}
Conditions hold <t: {}

Other prototypical policies

Local Delivery Timing (Device x)

Best Effort
Deliver by t

Action on Fail

Bounded deferral t

Conditions t:
Conditions flow <t: {}
Conditions hold <t: {}

Other prototypical policies

Device-specific hints

Device policy (alerting, timing, fidelity tradeoffs, UI, store): Device i

Conditional policies

```
Condition 1
    Policy 1
Condition 2
      Policy 2
      .
Condition n
    Policy n
```

Information Value
Capture core notion of discrete or scalar value of importance and/or urgency. Taken as
a core representation of information value for notification systems “urgency” of
messaging or communication.

```
Basic
  Discrete: High, Normal, Low
  Scalar: Range: Low..High [1..100]
Extended
  Function type, parameters
Linear (initial value, rate of loss)
```

Deadline, (initial value, total loss at time t)
Exp, (initial value, half-life)
Sigmoid, (initial value, parameters)
Step, (initial value, loss steps by time)
Complex (provide), e.g., Shelf, shelf-life + function/parameter
Other (parameters)

Conditional value
Condition 1

Value: { }

Condition 2

```
  Value: { }
    .
    .
  Condition n
  Value: { }
```

Information Volatility

Describes the disposition of the message over time.

```
Time to live (TTL) without review: delete after time x
  Action on delete (delete only, log, resend to other user, etc.)
Time to live (TTL) on device x
  Action on delete (delete only, log, resend to other user, etc.)
Replace: Replace uuid, class, or thread Id, etc. received most recently
Replace all: deliver, and delete all of same uuid, class, or thread Id, etc.
received earlier
Thread ID: Append to prior class, title, ID
Update attribute x in prior title, ID and delete
Default to delete upon review
Default to journal upon review
Other info volatility policies
Conditional Volatility:
```

Condition 1
.
.
Condition n

In general, a notification schema considers allowing routing policies to be written directly into a schema by source processes, versus always relying on a downstream information agent to infer routing policies from attributes of content, urgency and the like. Thus, some direct specification of policy preferences at the source should be enabled, and a notification schema should make it straightforward to encode policy via direct writing of routing preferences and policies into the schema, as hints.

The schema for the notification header may provide notification class, title, and a subscription identifier to identify the notification, and the notification may be stamped with a unique identifier and time. The overall .NET service provides the identity of the caller, application and platform. Other information may describe whether an automated agent or a person generated the notification, information volatility (e.g., Time to live data, replaceability with update, and so forth. Still other header information may specify whether the notification is replaceable with sameTitle, sameClass, and so on.

The schema for notification body provides attributes that detail the type of content in the body, e.g., textOnly, textAudio, textGraphics, AudioGraphics, and so on, and the size of the notification (e.g., in bytes). Notifications can also express their value, for example as scalar numbers, cost amounts, or qualitative tags (high, medium, low), so that the information agent service can determine whether and how to deliver the notification, as described below. Notifications also have the ability to express dynamics of value, that is, how values change over time with delays. Multiple functions are available, including deadline, stepwise, half-life and sigmoid functions.

In the schema, consideration may also be given to a privacy, authority model for writing and reading attributes of metadata to minimize “spamming” via the information agent. To this end, a standard tag for representing authorship of key fields (which fields in the schema, written or overwritten by which author and/or process) may be employed. The notification may thus provide security and authorization, by maintaining a record of who wrote and who can read attributes, as well as authenticating senders. Consideration may also be given to allowing the option of encoding preference information on rendering fidelity tradeoffs, summarization options, subscription information, path to remote-stored preferences, and so forth in the notification schema itself Also, as with other schemas described herein, a schema should employ required and optional fields to keep header size and processing lightweight. To this end, the use of standardized schemas that are potentially small or compact subsets of the notification schema (and similarly other schemas) may be used to keep messages lightweight relative to complete or extended schemas. Still further, tradeoffs in richness versus the need for header extensions for handling of real-time communications should be considered, as well as informational notifications (e.g., incoming and desired channel).

The notification schema can contain information about preferences for rendering of content in different ways, including preferences for rendering different approximations of the complete content of a message, depending on device capabilities. Content to be rendered can contain multiple components or types of information, e.g., text, HTML, graphics, video, audio, and combinations. To date, content encodings like MIME allow different devices to render a message based on rendering abilities and encoded policies. For a cross-device notification platform, different formulations of content can be encoded and transmitted for different devices. Also, preferences in the notification schema can be encoded to indicate preferences for different devices given the content at hand, and how different devices should best handle the rendering of portions of content, whether the content is of a single or of multiple types of information, based on device capabilities.

Rendering preferences allow for a piece of content to be summarized in different ways depending on the device rendering capabilities. Also, information about the ability to render and the fidelity of rendering may be an important consideration for making decisions about waiting for a device with an ability to render a more complete rendition of the information versus sending an approximate version of the information more immediately. For example, consider that a piece of content has graphics and text, e.g., directions to a location with a map graphic. A cell phone might be available now, but the device might only be able to render text on its small display. If the notification platform waits an hour, a desktop device with the ability to render both graphics and text may become available.

Content can be encoded in different ways for rendering by devices with different capabilities. In one approach, the content contains a distinct formulation for different classes of rendering ability. For example, an extended piece of text, containing more detailed descriptions, might be made available for the situation where the graphic is not available. For devices with text and graphics capability, content containing a shorter text description coupled with a graphic might be made available. Alternatively, a single piece of multipart content may be provided. In such a case, devices make an effort to render portions of the single multipart content that they can render, and drop the other information. Given these different approaches to handling content on different devices, there may be value in encoding preferences about rendering, and, potentially also, encoding different formulations of content that these preferences address. Such preference information can be used in a number of ways. As an example, a notification manager can provide value by reasoning about whether it is better to wait until a richer client is available, versus sending a portion of the content (e.g., directions without a map graphic). In another scenario, different devices may have different costs of usage. A notification manager may have the ability to reason about the informational value versus losses associated with rendering portions or summaries of content, based on the rendering abilities and bandwidth available. Also, a source or user may have different preferences about different subsets and types of renderings on different available devices.

The system is able to use hints per encodings related to matching device capabilities (e.g., fidelity) and rendering tradeoffs stamped by the source into notification schema, to use source preferences, or to follow policies based on a user's preferences about how to render content with multiple components (across media types) when that content cannot be fully rendered.

One way in which this may be accomplished is for the schema information to include preference ordering on approaches to content rendering. Another way is to provide a fidelity measure with each alternative rendering option. By way of example, consider an example of a notification about a traffic jam, containing directions about re-routing the user. The information contains audio on directions, a text description, and a map graphic. In this example, rendering on a device that can handle all three components (without truncation for the text) is assigned a fidelity of 1.0, while a device capable of handling only the map graphic and text is assigned a fidelity of 0.75, and one that can only handle the text is assigned a fidelity of 0.5. These preferences can be encoded as fidelity tags on different rendering types by the source, or can be stored as general policies in the user information preferences that overwrite or reorder the preferences encoded initially in the notification schema by the source.

As described above, several encodings are possible. For example, the source can send separate content blobs and indicate that the order represents the preferences. That is, the first one would be the best, then the next, and so on. Alternatively, each type of rendering set of abilities can be assigned a fidelity value between 0 and 1.0. Such fidelity values can be made content and context dependent. Further, a function may be encoded that captures how the fidelity will change with approximate renderings or the like. For example, the notification schema can contain a description of a functional form of fidelity for text rendering devices that allows fidelity to be assigned to any particular piece of text content, as a function of the portion of text that can be displayed. For example, fidelity can range from 1.0 to 0 as text is truncated from the complete text to truncated (pruned) text, as some function of the fraction of words remaining in the truncated text.

Thus, for each content rendering blob (of data), a fidelity may be listed. For a multipart, multicomponent blob, alternate renderings, each associated with a fidelity value, may be listed. User preferences may be accessed when decisions are made about timing and routing of information.

As an alternative to (or in addition to) being sent as its own message, schematized notification data may be embedded as an overlay on existing messaging and communication systems. For example, notification schema metadata may be included in the header (or hidden in the content) of email. Another example of providing a notification via a communication system includes overlaying the notification metadata on a telephone communication. In general, a schematized notification may accompany any transmission of data, and, as mentioned above, the encoding for the various schema metadata (such as the notification schema metadata) can be in different formats, e.g., the metadata may be encoded in MIME for SMTP (email), in XML for SOAP messages, or SIP, depending on the protocol and application.

Moreover, the development of a standard method for overlaying context-sensitivity and content-sensitivity on any key properties with conditional statements may be implemented, as in the following example:

Conditional Delivery:

| | |
|---|---|
| Condition 1: | If present at a full-client machine |
| 2: | If not present on a full-client machine |
| . | |
| . | |
| . | |
| Condition n | |

As can be appreciated, the present invention is not limited to any one notification schema, but rather includes numerous alternatives for any given schema. For example, the outline below describes information that may be used in an alternative notification schema. Note that elements in such a schema may be merged with other relevant elements to assemble a new schema, have other elements added thereto or removed therefrom, and otherwise modified and combined to form a schema. In general, the schemas and/or schema outlines described herein only provide examples of the type of information that may be used in a schema. The table below provides such an example:

<myNotifications changeNumber=”...”>

<notification

changeNumber=”...”

uuid=”...”
replace=”...”
threadId=”...”
class=”...”
id=”...”>0..unbounded

<identityHeader type=”user|automated”>

<senderUserReference/>
<branding

logo=”...”
alternativeText=”...”

/>
<!-- enable entities to add branding information

so that this alert shows through (e.g., an
URL to content, alt text, and/or an {any}
field.

-->

</identityHeader>
<timeInformation>

<creationTime>1..1</creationTime>
<receivedTime>1..1</receivedTime>

</timeInformation>
<subscriptionInfo>0..1</subscriptionInfo>[LF1]
<subscriptionContact>0..unbounded

<cat ref=”...”>1..1</cat>
<email>1..1</email>
<name>0..1</name>

</subscriptionContact>
<transmissionHistory>

<attemptedDelivery>0..unbounded

<time/>1..1
{any}

</attemptedDelivery>
<routingInfo sequence=”...”>

<!—tracks the hops the notification
took to get there-->

</routingInfo>0..unbounded
{any}

</transmissionHistory>
<!--Reliability and confirmation -->
<confirmation required=”true|false”/>
<failure type=”...”

policyId=”pointer to id”>0..unbounded

<action>

<journal set=”true|false” condition=”???”/>0..1
<reroute set=”true|false” condition=”???”
path=”someURI”/>0..1

</action>
</failure>
<!-- Body -->
<title xml:lang=”...” dir=”...”/>
<content

fidelity=”percent value indicating how good the content is”

>

<url/>
<contentType/>
<contentTransferEncoding/>
<size>
<rendererLocation>url to rendering

tool</rendererLocation>0..1

| | |
|---|---|
| <!-- | content should also support a |

pointer to MIME parts
need not resend this each time in multiple content
blocks

-->

<!-- Device preferences

Used to help an info agent figure Out which piece of
content to try to render on which

-->
<bandwidth to=”...” from=”... ”/>
<graphics x=”...” y=”... ” colors=”...”/>
<audio/><!-- need input on what audio req's look like -->
<userInput

keyboard=”none|full|alternate”
cursorControl=”...”
speech=”none|[name or uri of speech engine”
audio=”...”
video=”...”

/>
<clientUi path=”...”></clientUi>
{any}

</content>

<!-- Backchannel and relay requirements -->

<xsd:element

name=“backChannel”
type=“backChannelType”
minOccurs=“0”
maxOccurs=“1”

/>

<xsd:complexType name=“backChannelType”>

<xsd:annotation>

<xsd:documentation>

This element addresses the ability of the endpoint device to
send a message back to a component
(e.g., the user InfoAgent)
that wants to have knowledge that the notification got
through.

</xsd:documentation>

</xsd:annotation>

<xsd:sequence>

<xsd:element

name=”confirmAbilities”
type=”hs:string”
minOccurs=”0”
maxOccurs=”unbounded”
>
<xsd:annotation>

<xsd:documentation>

this elements describes the device's abilities to
confirm of notification delivery and
processing. for example, “onReceive” means to
confirm when the device receives a notification
“onOpen” means to confirm when a user
reviews a notification “explicit”: means to
confirm when a user explicitly expresses the
request to confirm e.g. push a button) a
notification (alternatively implement with
enum type of “onReceive”, “onOpen”,
“explicit”, “onReceive+onOpen”,
“onReceive+explicit”, “onOpen+explicit”,
“onReceive+onOpen+explicit” -->

</xsd:documentation>

</xsd:annotation>

</xsd:element>
<xsd:element

name=“deviceContext”
type=“hs:string”
minOccurs=“0”
maxOccurs=“unbounded“
>

<xsd:annotation>

<xsd:documentation>

this element describes the device status
a device is capable to send back to a
component. The possible statuses are
in use or not, in motion or not,
application status on the device, last
time the device was used.

</xsd:documentation>

</xsd:annotation>

</xsd:element>
<xsd:element

name=“localRelay”
type=“xsd:boolean”
minOccurs=”0”
maxOccurs=”1”
>
<xsd:annotation>

<xsd:documentation>

can the device sends back the list of
rich applications it could relay the
notification to
<!-- I think the list of rich UI
applications should be sent in the back
channel communication instead of be
listed here

-->

</xsd:documentation>

</xsd:annotation>

</xsd:element>

</xsd:sequence>

</xsd:complexType>
<!-- Routing and alerting hints -->

<routingConditions>

<!--

May alternatively use a single device, device set, etc. Any
condition uses a pointer to myDevices

-->

<if select =”...”>

<deviceId/>0..1</deviceId>

<deviceCat> [concept of a sequence, points to a

category of devices.]
</deviceCat>

</if>
<else select=”...”/>

```
  </routingConditions>
  <deliveryTiming bestEffort=”true|false”>
```

<deliverBy time=”...”>

<onFail action=”...”/>

</deliverBy>
<!--

Don't do anything until ... hold this until ... Unless X
happens
... or
Do as soon as possible, but hold it until a maximum of
time t
Bounded deferral t

Conditions t:
Conditions flow <t: {}
Value: {}

.
.

Condition n
Value: {}

</deliveryTiming>

<informationVolatility>

<timeToLive deleteAfter=”...”

deviceId=”*|deviceId”
delete=”true|false”
log=”true|false”
retransmit=”true|false”

/>0..unbounded
<!--
Alternatives may include:

Replace: replace uuid, class or thread Id,
etc. received most
recently. Replace all: deliver, and delete
all of same uuid, class
or thread Id etc. received earlier
Thread Id: append to prior
class, title, ID Update attribute X in prior title,
ID and delete
Default to delete upon review Default to
journal upon review
Other info volatility policies

-->

.Net notifications

The .NET Notification (myNotification) service is designed to deliver notifications to an identity. This service can be used by any application or service to send and/or receive notifications rooted from an identity. The service represents itself as queue of notifications, that can be pushed via a SOAP message using SMXP routing or polled via the query method.

Logically, the myNotifications service is broken up into distinct sections as represented by the content XML document, including notifications, the section that contains the queue of notifications. Each notification is defined by a standardized schema, with attributes that assist consumers of these notifications in scoping which notifications are interesting or not. The body of the notification can be customized by each notification provider. Notifications may be handled in different ways depending on the configuration of the service and the nature of the notification. For example, notifications may reside in this queue until their “Time to live” parameter expires, regardless whether they have been read or not.

Another section is the notification streams section, which contains the list of notification streams currently active against the myNotification service for a given identity. A notification contains two elements, namely an SMXP message path used to route (i.e. push) notifications to their final destination, and a scoping expression (i.e. XPATH) used to filter what notifications are sent down the message path. A notification stream is registered with myNotifications for a given identity, by adding/updating notificationStream element(s) to the notificationStreams section of the document using the common add, update methods.

Another section is the notification preferences section, which contains various notification preferences, including a doFirst SMXP message path element, which users can set such that the myNotifications service automatically routes incoming notifications to the specified path. This is accomplished by simply chaining this path into the path specified in a notification stream. The doFirst path is important for use with decision making notification routers that obtain the notification first in order to do some processing prior to it being routed to its final destination.

When a new notification is added into the myNotifications queue for an identity, (via the addNotification method), the following logic occurs within the myNotifications service, as shown below:

```
foreach notificationStream in notificationStreams
{
  if (notificationStream.location MATCHES notification)
  {
    if (notificationPreferences.doFirstPath)
    {
      pushPath = notificationPreferences.doFirstPath +
      notificationStream.path;
      status = push(notification, pushPath);
      registerErrorStatus(status, pushPath, notificationStream);
    }
    else
    {
      status = push(notification, notificationStream.path);
      registerErrorStatus(status, notificationStream.path,
      notificationStream);
    }
}
```

To summarize, when a new notification enters the myNotifications queue, the service iterates through each notificationStream registered in the notificationStreams section and attempts to match the notificationStream's location expression against the new notification. If a successful match occurs, myNotifications will attempt to push the notification to the notificationStream's path unless a global doFirstPath is registered in notificationPreferences. Note that the service does not stop because a match occurred on a stream. Instead, the service inspects each registered notification stream to see if the notification satisfies other streams as well. In this way, multiple readers of the notification stream are supported. If significant sequential errors are detected while pushing notifications down that message path, the message path is deleted.

Notifications may be read by using the standard query method, however the preferred method is for myNotifications to push the notification via a SOAP message using SUP routing mechanisms. In order to accomplish this push mechanism, clients need to have an SMXP aware connection to the myNotifications service, which, for example, may be accomplished by calling the getChannelAddress method, which yields an smxp://mynotifications.microsoft.net: 1280 type of response. Given this URI, the client can connect and bind to this address.

Once a successful connection is established, the myNotifications service names this message Path (e.g., 'vid=″cid:12385345@mynotifications.microsoft.net′″). The naming of this message Path is accomplished by sending a getChannelName message on the just established channel. Once the message path is successfully named, both clients and the myNotification service may use this name to describe a section in a message path which details how messages are routed to their final destination. These message paths can be set with optional filters in the notificationStreams section of the service.

Each notification contains a Time to Live field <notificationTTL>. Once the specified time expires, the notification may be deleted or logged from the queue (depending on the setting). Notification providers that generate the notification set this Time to Live value based on internal defaults or other user preferences.

Each notification is standardized by the NET schemas, but applications can use the body element to add additional information that is not described in the notification schema. Addition of free form data is allowed within the body, but use of the schematized extensions within the body element is encouraged to allow shredding of the XML data as well as queries within.

```
scope allElements
<hs:scope id=7215df55-e4af-449f-a8e4-72a1f7c6a987>
  <hs:shape base=t>
  </hs:shape>
</hs:scope>
scope onlySelfElements
<hs:scope id=a159c93d-4010-4460-bc34-5094c49c1633>
  <hs:shape base=nil>
    <hs:include select=//*[@creator=‘$callerId’]/>
  </hs:shape>
</hs:scope>
scope onlySelfSubscriptionElements
<hs:scope id=b7f05a6d-75cd-4958-9dfb-f532ebb17743>
  <hs:shape base=nil>
    <hs:include select=//subscription[@creator=‘$callerId’]/>
  </hs:shape>
</hs:scope>
scope onlyPublicElements
<hs:scope id=da025540-a0c0-470f-adcf-9f07e5a5ec8f>
  <hs:shape base=nil>
    <hs:include select=//*[cat/@ref=‘hs:public’]/>
    <hs:include select=//subscription[@creator=‘$callerId’]/>
  </hs:shape>
</hs:scope>
```

The NET Notifications roleTemplate rt0 role gives give complete read/write access to the information within the content document of the service being protected through this roleTemplate. The following table illustrates the available methods and the scope in effect when accessing the NET Notifications service through that method while mapped to this roleTemplate.

TABLE
.NET Notifications roleTemplate rt0

| method | scope/name |
|---|---|
| query | allElements |
| insert | allElements |
| replace | allElements |
| delete | allElements |
| update | allElements |

The NET Notifications roleTemplate rt I role gives complete read access to all information within the content document of the service being protected through this roleTemplate. Applications mapping to this role also have a limited ability to write to information in the content document. Applications may create nodes in any location, but may only change/replace, or delete nodes that they created. The following table illustrates the available methods and the scope in effect when accessing the NET Notifications service through that method while mapped to this roleTemplate:

TABLE
.NET Notifications roleTemplate rt1

| method | scope/name |
|---|---|
| Query | allElements |
| Insert | onlySelfElements |
| Replace | onlySelfElements |
| Delete | onlySelfElements |

The .NET Notifications roleTemplate rt2 gives complete read access to all information within the content document of the service being protected through this roleTemplate. Applications mapping to this role have very limited write access and are only able to create and manipulate their own subscription nodes. The following table illustrates the available methods and the scope in effect when accessing the NET Notifications service through that method while mapped to this roleTemplate.

TABLE
.NET Notifications roleTemplate rt2

| method | scope/name |
|---|---|
| query | allElements |
| insert | onlySelfSubscriptionElements |
| replace | onlySelfSubscriptionElements |
| delete | onlySelfSubscriptionElements |

The .NET Notifications roleTemplate rt3 gives limited read access to information within the content document that is categorized as “public.” The following table illustrates the available methods and the scope in effect when accessing the NET Notifications service through that method while mapped to this roleTemplate:

TABLE
.NET Notifications roleTemplate rt3

| method | scope/name |
|---|---|
| query | onlyPublicElements |

The .NET Notifications roleTemplate rt99 blocks access to the content document. Note that lack of a role in the roleList has the same effect as assigning someone to rt99. The following table illustrates that there are no available methods and the scope in effect when accessing the .NET Notifications service through that method while mapped to this roleTemplate (note that in other services described herein, such an empty table will not be repeated):

TABLE
.NET Notifications roleTemplate rt99

| | |
|---|---|
| method | scope/name |

.NET Notification (myNotifications)—content

The Notification content document based on the notification schema is an identity-centered document. Its content and meaning are a function of the Passport Unique ID (PUID) used to address the service. Access to the document is controlled by the associated roleList document. This schema outline illustrates the layout and meaning of the information found in the content document for the myNotifications service. The format is similar to those presented in the aforementioned U.S. patent application Ser. No. 10/017,680.

```
<m:myNotifications changeNumber=“...” instanceId=“...”
  xmlns:m=“http://schemas.microsoft.com/hs/2002/04/myNotifications”
  xmlns:hs=“http://schemas.microsoft.com/hs/2002/04/core”>_{1..1}
  <m:notification changeNumber=“...” uuid=“...”
  replace=“...” threadId=“...”
class=“...” id=“...”>_{0..unbounded}
    <m:notificationId>_{0..1}
      <m:timeStamp>_{1..1}</m:timeStamp>
      <m:trackingNumber>_{1..1}</m:trackingNumber>
    </m:notificationId>
    <m:identityHeader type=“...”>_{1..1}
      <m:onBehalfOfUser>_{1..1}</m:onBehalfOfUser>
      <m:licenseHolder>_{1..1}</m:licenseHolder>
      <m:platformId>_{1..1}</m:platformId>
    </m:identityHeader>
    <m:title xml:lang=“...” dir=“...”>_{0..1}</m:title>
    <m:notificationTTL action=“...”>_{0..1}
      <m:TTL>_{1..1}</m:TTL>
    </m:notificationTTL>
    <m:informationValue type=“...”>_{0..1}
      <m:value>_{0..1}</m:value>
      <m:function type=“...”>_{0..1}
        <m:parameters>_{0..1}</m:parameters>
      </m:function>
      <m:conditional>_{1..1}
        <m:context>_{0..1}</m:context>
        <m:value>_{0..1}</m:value>
        <m:function type=“...”>_{0..1}
          <m:parameters>_{0..1}</m:parameters>
        </m:function>
      </m:conditional>
    </m:informationValue>
    <m:siteUrl>_{0..1}</m:siteUrl>
    <m:actionPath>_{0..1}</m:actionPath>
    <m:ackPath>_{0..1}</m:ackPath>
    <m:subscriptionPath>_{0..1}</m:subscriptionPath>
    <m:bodyImageUrl>_{0..1}</m:bodyImageUrl>
    <m:body>_{0..1} {any}</m:body>
    <m:endPointDelivered>_{0..unbounded}</m:endPointDelivered>
  </m:notification>
  <m:notificationEndPoint changeNumber=“...”
  type=“...” id=“...”>_{0..unbounded}
    <m:name>_{1..1}</m:name>
    <m:deviceUuid>_{1..1}</m:deviceUuid>
    <m:path>_{1..1}</m:path>
    <m:xpLocation>_{0..1}</m:xpLocation>
    <m:sequentialErrorCount>_{0..1}</m:sequentialErrorCount>
  </m:notificationEndPoint>
  <m:notificationPreference changeNumber=“...” id=“...”>_{0..1}
    <m:doFirstPath>_{0..1}</m:doFirstPath>
    <m:logPath>_{0..1}</m:logPath>
    <m:sequentialErrorCount>_{0..1}</m:sequentialErrorCount>
  </m:notificationPreference>
</m:myNotifications>
```

The meaning of the attributes and elements shown in the preceding sample document fragment are listed in the following section. The /myNotifications (minOccurs=1maxOccurs=1) /myNotifications/@changeNumber (minOccurs=1 maxOccurs=1) /myNotifications/@instanceId (minOccurs=0 maxOccurs=1) /myNotifications/notification (minOccurs=0 maxOccurs=unbounded) /myNotifications/notification/®changeNumber (minOccurs=1 maxOccurs=1) elements identify the notification document and provide version data. The /myNotifications/notification/@uuid (minOccurs=0 maxOccurs=1) attribute contains the uuid chosen by the application during subscribe time. Its primary use is to support multiple readers of notifications from the same class of service.

The /myNotifications/notification/@replace (minOccurs=0 maxOccurs=1) describes whether a later notification can replace this notification. Possible values include “sameUuid”, “sameClass”, and “sameThreadId.” The /myNotifications/notification/@threadId (minOccurs=0 maxOccurs=1) field provides the notification thread id; notifications with the same thread id can be collapsed. The /myNotifications/notification/@class (minOccurs=0 maxOccurs=1) attribute contains a URI that specifies what class of notificationProvider created this notification. The class defines what the body of the notification will contain.

The /myNotifications/notification/@id (minOccurs=maxOccurs=1) /myNotifications/notification/notificationId (minOccurs=0 maxOccurs=1) /myNotifications/notification/notificationId/timeStamp (minOccurs=1 maxOccurs=1) timeStamp details when the notification was received by the notification service and inserted into an identities queue. This is referred to as Time zero for a notification.

The /myNotifications/notification/notificationId/trackingNumber (minOccurs=1 maxOccurs=1) element contains a unique Id generated by the myNotifiations service for tracking purposes. It is used to uniquely identify every distinct notification that passes through the system. This value is not assigned by user, application, or notification provider.

The /myNotifications/notification/identityHeader (minOccurs=1 maxOccurs=1) /myNotifications/notification/identityHeader/type (minOccurs=0 maxOccurs 1) type attribute presently has only two possible values: User or Automated. If the value is User, the notification was generated by a real user identity. If the value is Automated, this notification was generated from an automated agent.

The /myNotifications/notification/identityHeader/onBehalfOftser (minOccurs=1 maxOccurs=1) element contains the identity header element describing the user who inserted this notification into the queue.

The /myNotifications/notification/identityHeader/licenseHolder (minOccurs=1 maxOccurs=1) element contains the identity header element describing the application who inserted this notification into the queue. The /myNotifications/notification/identityHeader/platformId (minOccurs=1 maxOccurs=1) element contains the identity header element describing the platformId who inserted this notification into the queue.

The /myNotifications/notification/title (minOccurs=0 maxOccurs=1) optional element contains the title of the notification from a specific class. Its primary use is to help group the same type of notification from the same class. For example, class=“http://schemas.microsoft.com/moneycentral” and title=“MSFT stock quote”.

The /myNotifications/notification/title/@xml:lang (minOccurs=maxOccurs=1) required attribute is used to specify a language code compliant with RFC 3066 as described in RFC 3066 (more information is available from the W3C). If the language code is unknown, a value of “und” should be used, as per RFC 3066. Applications are expected to undertake reasonable effort to determine the input language and store it with the data. Applications should preserve a previously set xml:lang attribute in cases in which the string itself in not changed by the application. The/myNotifications/notification/title@(dir (minOccurs=0 maxOccurs=1) optional attribute specifies the default layout direction for the localized string. Valid values are rtl (right to left) and ltr (left to right).

The /myNotifications/notification/notificationTTL (minOccurs=0 maxOccurs 1) /myNotifications/notification/notificationTTL/@action (minOccurs=0 maxOccurs=1) action attribute details what is done with the notification after the Time to Live expires. There are presently two possible values, delete or log. Delete will delete the notification once the time has expired, while log will log it to user storage (logPath within notificationPreferences points where it will be logged). The /myNotifications/notification/notificationTTL/TTL (minOccurs=1 maxOccurs=1) element specifies when (in UTC) the notification should be expired.

The /myNotifications/notification/informationValue (minOccurs=0 maxOccurs=1) /myNotifications/notification/informationValue/@type (minOccurs=0 maxQccurs=1) /myNotifications/notification/informationValue/value (minOccurs=0 maxOccurs=l) /myNotifications/notification/informationValue/function (minOccurs=0 maxOccurs=l) /myNotifications/notification/informationValue/function/@type (minOccurs=0 maxOccurs=1) /myNotifications/notification/informationValue/function/parameters (minOccurs=0 maxOccurs=1) /myNotifications/notification/informationValue/conditional (minOccurs=1 maxOccurs=1) /myNotifications/notification/informationValue/conditional/context (minOccurs=0 maxOccurs=1) /myNotifications/notification/informationValue/conditional/value (minOccurs=0 maxOccurs=1) /myNotifications/notification/informationValue/conditional/function (minOccurs=0 maxOccurs=1) /myNotifications/notification/informationValue/conditional)function/(type (minOccurs=0 maxOccurs=1) /myNotifications/notification/infornationValue/conditional/function/parameter s (minOccurs=0 maxOccurs=1) fields contain the notification data.

The /myNotifications/notification/siteUrl (minOccurs=0 maxOccurs=1) optional element encapsulates the base URL to which the notification can be traced. The other Url types are rooted from here. The /myNotifications/notification/actionPath (minOccurs=0 maxOccurs=1) optional element encapsulates the path from the base URL used to perform any action requested by this notification. The /myNotifications/notification/ackPath (minOccurs=0 maxOccurs=1) optional element encapsulates the path from the base URL used to perfom any acknowledgment requested by this notification. The /myNotifications/notification/subscriptionPath (minOccurs=0 maxOccurs=1) optional element encapsulates the path from the base URL used to perfom any subscription adjustments that generated this notification. The /myNotifications/notification/bodylmageUrl (minOccurs=0 maxOccurs=1) optional element encapsulates an URL to an Image (icon/branding) used to identify this notification. This can also be a local URL.

The /myNotifications/notification/body (minOccurs=0 maxOccurs=1) /myNotifications/notification/body/{ any} (minOccurs=0 maxOccurs=unbounded) allows for extended notification data.

The /myNotifications/notification/endPointDelivered (minOccurs=0 maxOccurs=unbounded) element specifies endPoints this notification has been delivered to.

The /myNotifications/notificationEndPoint (minOccurs=0 maxOccurs=unbounded) /myNotifications/notificationEndPoint/(changeNumber (minOccurs=1 maxOccurs=1) /myNotifications/notificationEndPoint/@type (minOccurs=0 maxOccurs1) details what kind of end point, for example, “SOAP-RP”, “SMTP”, “SMS”, “UDP”, “HTTP”, “TCP” and so forth. The /myNotifications/notificationEndPoint/@id (minOccurs=maxOccurs 1) /myNotifications/notificationEndPoint/name (minOccurs=1 maxOccurs=1) optional element provides a descriptive name for this end point. The /myNotifications/notificationEndPoint/deviceUuid (minOccurs=1 maxOccurs=1) optional element provides a place to store the device UUID for this notification end point. It can be used to retrieve presence info from myPresence for intelligent routing. The /myNotifications/notificationEndPoint/path (minOccurs=1maxOccurs=1) element contains the path expression that defines the message path for the end point. The syntax of this element is determined by the end point type. For example, if it is SMTP, the path is in the format of “user1@microsoft.net”.

The /myNotifications/notificationEndPoint/xpLocation (minOccurs=0 maxOccurs=1) location element is used to help scope the notification matching. The /myNotifications/notificationEndPoint/sequentialErrorCount (minOccurs=0 maxOccurs=1) location contains the number of serious sequential errors detected while pushing notifications along this path. Once this reaches a predetermined count, the service determines that the path is unreachable, and this notificationEndPoint is removed.

The /myNotifications/notificationPreference (minOccurs=0 maxOccurs=1) /myNotifications/notificationPreference/@changeNumber (minOccurs=1 maxOccurs=1) /myNotifications/notificationPreference/@id (minOccurs=1 maxOccurs=1) detail preference data.

The /myNotifications/notificationPreference/doFirstPath (minOccurs=0 maxOccurs=1) optional element expresses the global SOAP-RP message path to route SOAP messages first. The /myNotifications/notificationPreference/logPath (minOccurs=0 maxOccurs=1) optional element is a URI that points to user supplied storage used to log notifications when they expire (as specified in notificationTTL).

The /myNotifications/notificationPreference/sequentialErrorCount (minOccurs=0maxOccurs=1) location contains the number of serious sequential errors detected while pushing notifications along this path. Once this reaches a predetermined count, the service determines that the path is unreachable, and the doFirstPath is deleted.

.NET Notifications (myNotifications)—System

The system document is a global document for the service. Its content and meaning are independent of the Passport Unique ID (PUID) used to address the service, and the document is read only to all users. The system document contains a set of base items common to all .NET My Services, and is optionally extended by each service to include service-specific global information.

This schema outline illustrates the layout and meaning of the information found in the system document for the myNotifications service:

```
<sys:system changeNumber=“...” instanceId=“...”
  xmlns:hs=“http://schemas.microsoft.com/hs/2002/04/core”
  xmlns:sys=“http://schemas.microsoft.com/hs/2002/04/myNotifications/system”>_{1..1}
  <hs:systemVersion changeNumber=“...” id=“...”>_{1..1}
    <hs:version minorVersion=“...” majorVersion=“...” qfe=“...” buildNumber=“...”>_{1..1}
      <hs:productReleaseName>_{1..1}</hs:productReleaseName>
      <hs:productImplementationName>_{1..1}</hs:productImplementationName>
    </hs:version>
    <hs:buildDate>_{1..1}</hs:buildDate>
    <hs:buildDetails machine=“...” type=“...” branch=“...”
official=“...”>_{1..1}</hs:buildDetails>
  </hs:systemVersion>
  <hs:roleMap changeNumber=“...” id=“...”>_{1..1}
    <hs:scope id=“...”>_{0..unbounded}
      <hs:name xml:lang=“...” dir=“...”>_{0..unbounded}</hs:name>
      <hs:shape base=“...”>_{1..1}
        <hs:include select=“...”>_{0..unbounded}</hs:include>
        <hs:exclude select=“...”>_{0..unbounded}</hs:exclude>
      </hs:shape>
    </hs:scope>
    <hs:roleTemplate name=“...”>_{0..unbounded}
      <hs:fullDescription xml:lang=“...” dir=“...”>_{0..1}</hs:fullDescription>
      <hs:method name=“...” scopeRef=“...”>_{0..unbounded}</hs:method>
    </hs:roleTemplate>
  </hs:roleMap>
  <hs:methodMap changeNumber=“...” id=“...”>_{1..1}
    <hs:method name=“...”>_{0..unbounded} {any}</hs:method>
  </hs:methodMap>
  <hs:schemaMap changeNumber=“...” id=“...”>_{1..1}
    <hs:schema namespace=“...” schemaLocation=“...” alias=“...”>_{0..unbounded}
{any}</hs:schema>
  </hs:schemaMap>
  <hs:wsdlMap changeNumber=“...” id=“...”>_{1..1}
    <hs:wsdl wsdlLocation=“...”>_{0..unbounded} {any}</hs:wsdl>
    <hs:disco discoLocation=“...”>_{0..unbounded} {any}</hs:disco>
    <hs:wsil wsilLocation=“...”>_{0..unbounded} {any}</hs:wsil>
  </hs:wsdlMap>
  {any}
</sys:system>
```

The meaning of the attributes and elements shown in the preceding sample document fragment are listed below. The /system (minOccurs=1maxOccurs=1) element encapsulates the system document for the Microsoft® .NET Notifications service. The /system/@changeNumber (minOccurs=1maxOccurs=1) /system/instanceId (minOccurs=0 maxOccurs=1) /system/systemVersion (minOccurs=1 maxOccurs=1) /system/systemVersion/changeNumber (minOccurs=1 maxOccurs=1) /system/systemVersion/@id (minOccurs=1 maxOccurs=1) /system/systemVersion/version (minOccurs=1 maxOccurs=1), /system/systemVersion/version/@minorVersion (minOccurs=1 maxOccurs=1) attributes identify the system and version information of the NET service.

The /system/systemVersion/version/@majorVersion (minOccurs=1 maxOccurs=1) attribute specifies the major version number of the NET service, while the /system/systemVersion/version/@qfe (minOccurs=1maxOccurs=1) attribute specifies the quick-fix engineering (QFE) version number of the .NET service. The /system/systemVersion/version/@buildNumber (minOccurs=1 maxOccurs=1) attribute specifies the build number of the NET service. The /system/systemVersion/version/productReleaseName (minOccurs=1 maxOccurs 1) element defines the major product release string (for example, “.NET My Services Beta 1”.)

The /system/systemVersion/version/productImplementationName (minOccurs=1 maxOccurs=1) element defines the class of the service to differentiate between different implementations. The /system/systemVersion/buildDate (minOccurs=1 maxOccurs=1) element defines the date and time that the NET My Services system was built, in UTC (Z-relative) form. The /system/systemVersion/buildDetails (minOccurs=1 maxOccurs=1) /system/systemVersion/buildDetails/@machine (minOccurs=1 maxOccurs=1) attribute specifies the machine that generated the build. The /system/systemVersion/buildDetails/(type (minOccurs 1 maxOccurs−1) attribute specifies the type of build. A value of chk indicates that this is a checked or debug build. A value of fre indicates that this is a retail build.

The /system/systemVersion/buildDetails/@branch (minOccurs=1 maxOccurs=1) attribute specifies the software branch ID for the source code that contributed to this build. The /system/systemVersion/buildDetails/(official (minOccurs=1 maxOccurs=1) attribute indicates whether the build was produced by an official build process (value of yes), or an unofficial process (value of no).

The /system/roleMap (minOccurs=1 maxOccurs=1) /system/roleMap/(changeNumber (minOccurs1 maxOccurs 1) /system/roleMap/@id (minOccurs=1 maxOccurs 1) /system/roleMap/scope (minOccurs=0 maxOccurs=unbounded) element defines a scope which may be referred to by roles within this roleMap to indicate what portions of the document are visible to this role for the specified method, along with the /system/roleMap/scope/(id (minOccurs=0 maxOccurs=1)/system/roleMap/scope/name (minOccurs=0 maxOccurs=unbounded) elements.

The /system/roleMap/scope/name/@xml:lang (minOccurs=1 maxOccurs=1) required attribute is used to specify a language code compliant with RFC 3066 as described in RFC 3066; more information is available from the W3C. If the language code is unknown, a value of “und” should be used, as per RFC 3066. Applications are expected to undertake a reasonable effort to determine the input language and store it with the data. Applications should preserve a previously set xml:lang attribute in cases in which the string itself in not changed by the application.

The /system/roleMap/scope/name/@dir (minOccurs=0 maxOccurs=1) optional attribute specifies the default layout direction for the localized string. Valid values are rtl (right to left) and ltr (left to right). The /system/roleMap/scope/shape (minOccurs−1 maxOccurs=1) /system/roleMap/scope/shape/@base (minOccurs=0 maxOccurs=1) attribute specifies the initial set of nodes visible through the shape. A value of t indicates that the shape is initialized to include all possible nodes relative to the shape that is currently in effect. For instance, each role defines a scope containing a shape. When defining a shape for a role, the value t indicates all possible nodes available in the specified document for this role. When defining a shape in an ACL entry, a value of t means all of the nodes visible in the shape for the computed role. When using a shape in an hsdl operation, a value of t indicates all of the possible nodes selected by the hsdl operation (relative to the ACL shape which itself is relative to the role's shape). The value nil indicates the opposite of t, which is the empty node set. Nodes from this set may then be included into the shape.

The /system/roleMap/scope/shape/include (minOccurs=0 maxOccurs=unbounded) element specifies the set of nodes that should be included into the shape relative to the possible set of nodes indicated by the base attribute. The /system/roleMap/scope/shape/include/@select (minOccurs=1 maxOccurs 1) /system/roleMap/scope/shape/exclude (minOccurs=0 maxOccurs=unbounded) element specifies the set of nodes that should be excluded from the shape relative to the possible set of nodes indicated by the base attribute. The /system/roleMap/scope/shape/exclude/@select (minOccurs=1 maxOccurs=1)/system/roleMap/roleTemplate (minOccurs=0 maxOccurs=unbounded) element encapsulates the definition of a role. The attribute set for this element includes the document class that this roleTemplate refers to, the name of the roleTemplate, and the priority of the roleTemplate.

The/system/roleMap/roleTemplate/@name (minOccurs=1 maxOccurs=1) element specifies the name of the role. The /system/roleMap/roleTemplate/fullDescription (minOccurs=0 maxOccurs=1) element contains a description of this roleTemplate that specifies the capabilities a caller will have when accessing information through this role. The /system/roleMap/roleTemplate/fullDescription/@xml:lang (minOccurs=1 maxOccurs 1) required attribute is used to specify a language code compliant with RFC 3066 as described in RFC 3066; more information is available from the W3C. If the language code is unknown, a value of “und” should be used, as per RFC 3066. Applications are expected to undertake a reasonable effort to determine the input language and store it with the data. Applications should preserve a previously set xml:lang attribute in cases in which the string itself in not changed by the application. The /system/roleMap/roleTemplate/fullDescription/(dir (minOccurs=0 maxOccurs=1) optional attribute specifies the default layout direction for the localized string. Valid values are rtl (right to left) and ltr (left to right).

The /system/roleMap/roleTemplate/method (minOccurs=0 maxOccurs=unbounded) element specifies the methods available within this roleTemplate by name and by scope. When a subject maps to a roleTemplate, the method in the request must match one of these elements for the message to continue to flow. If the method exists, the data available to the method is a function of the scope referenced by this method, combined with an optional scope referenced by the role defined in the roleList. The /system/roleMap/roleTemplate/method/@name (minOccurs=1 maxOccurs=1) element specifies the name of the method. The /system/roleMap/roleTemplate/method/@scopeRef (minOccurs=1 maxOccurs=1) attribute specifies the scope within this document that is in effect for this method.

The /system/methodMap (minOccurs=1 maxOccurs=1) /system/methodMap/(changeNumber (minOccurs=1 maxOccurs=1) /system/methodMap/@id (minOccurs=1 maxOccurs=1) /system/methodMap/method (minOccurs=0 axOccurs=unbounded) fields provide method-related data. The /system/methodMap/method/@name (minOccurs=1 maxOccurs=1) attribute specifies the name of a method available within this service. The /system/methodMap/method/{any} (minOccurs=0 maxOccurs=unbounded) provides for extensibility.

The /system/schemaMap (minOccurs=1 maxOccurs=1) /system/schemaMap/@changeNumber (minOccurs=1 maxOccurs=1) /system/schemaMap/@id (minOccurs=1 maxOccurs=1) /system/schemaMap/schema (minOccurs=0 maxOccurs=unbounded) provide schema map data. The /system/schemaMap/eschema/@namespace (minOccurs=1 maxOccurs=1) attribute specifies the namespace URI of this schema. The /system/schemaMap/schema/@schemaLocation (minOccurs=1 maxOccurs=1) attribute specifies the location (in the form of a URI) of the resource containing the schema. When a schema is reachable through a variety of URIs, one schema element will exist for each location. The/system/schemaMap/schema/@alias (minOccurs=1 maxOccurs=1) attribute specifies the preferred alias to be used, if possible, when manipulating information covered by this schema in the context of this service. The /system/schemaMap/schema/{any} (minOccurs=0 maxOccurs=unbounded)/system/wsdlMap (minOccurs=1 maxOccurs=1)/system/wsdlMap/@changeNumber (minOccurs=1 maxOccurs=1) /system/wsdlMap/@id (minOccurs=1 maxOccurs=1) provide WSDL-related data. The/system/wsdlMap/wsdl (minOccurs=0 maxOccurs=unbounded) element is used to specify the location of a WSDL file for this service. Multiple entries may exist pointing to the same file hosted in multiple locations, or to variations on the content within the WSDL files. The/system/wsdlMap/wsdl@wsdlLocation (minOccurs=1 maxOccurs=1) attribute is a URI that specifies the location of the WSDL file. The /system/wsdIMap/wsdl/{any} (ninOccurs=0 maxOccurs=unbounded) provides for extensibility.

The/system/wsdlMap/disco (minOccurs=0 maxOccurs=unbounded) element is used to specify the location of a DISCO file for this service. Multiple entries may exist pointing to the same file hosted in multiple locations, or to variations on the content within the DISCO files. The /system/wsdIMap/disco/@discoLocation (minOccurs=1 maxOccurs=1) attribute is a URI that specifies the location of the DISCO file. The /system/wsdlMap/disco/{any} (minOccurs=0 maxOccurs=unbounded) provides for extensibility.

The /system/wsdlMap/wsil (minOccurs=0 maxOccurs=unbounded) element is used to specify the location of a WSIL file for this service. Multiple entries may exist pointing to the same file hosted in multiple locations, or to variations on the content within the WSIL files. The/system/wsdlMap/wsil/@wsilLocation (minOccurs=1 maxOccurs=1) attribute is a URI that specifies the location of the WSIL file. The/system/wsdlMap/wsil/{any} (minOccurs=0 maxOccurs=unbounded) /system/{any} (minOccurs=0 maxOccurs=unbounded) field provides for extensibility.

.NET Notifications (myNotification)—/Methods

The myNotifications service supports the standard methods as described in the aforementioned U.S. patent application Ser. No. 10/017,680.

myAlerts

In one alternative implementation, the Microsoft®.NET Alerts service, generally referred to as myAlerts, provides a single point where short messages can be sent to a specific user and transparently routed to that user's applications or devices. This particular service uses an XML schema to describe Alerts, and the methods by which Alerts can be sent and received. In general, the myAlerts service processes alerts (also referred to as notifications and/or events).

In keeping with the present invention, an alert is defined as embeddable XML, specifying both standard schema and extensible problem-domain schema, using the problem-domain schema as alert typing. The standard schema is generally directed to conveying alerts, regardless of what the alert is trying to convey. The problem-domain schema extension is used in a dynamically programmable Alert processing mechanism to control alert routing. Like other NET My Services, NET Alerts is designed to service the user instead of a particular device or application. Although alerts are posted to a single location, the messages are transparently routed to one or more of the user's applications or devices. The logic for deciding how, where, and when a message is delivered can be customized to meet the needs of a particular user, device, or application.

The myAlerts service includes mechanisms to deliver alerts, comprising a basic model mechanism that provides the baseline functionality of sending and receiving alerts. A streams model mechanism includes more robust features, such as filtering, buffering, and persistence, as well as more refined control over the routing of alerts.

As used herein, a client is any entity that can issue an XMI request to the .NET Alerts service. Clients can send or receive alerts, wherein an alert typically comprises a short XML message delivered to one or more users by NET Alerts. A receiver is a NET My Services user who has one or more applications that can receive alerts. Such an application is referred to herein as a userAgent. A userAgent includes any code on any device that can communicate with NET Alerts.

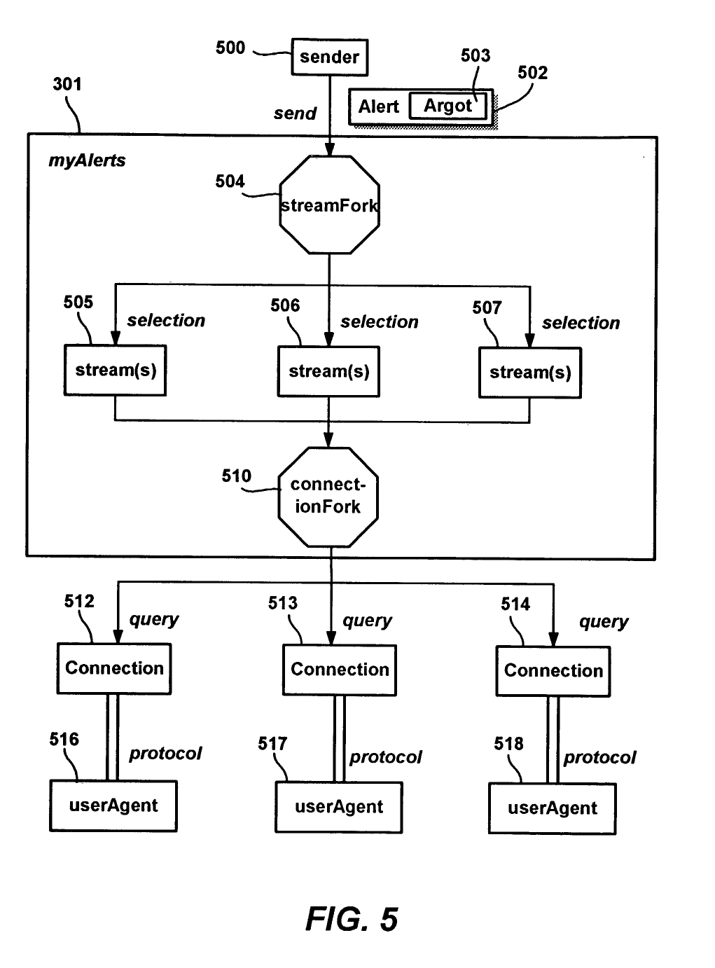

The myAlerts service provides a variety of ways to communicate with userAgents. For example, as generally represented in FIG. 5, a sender 500 may send an alert 502 by issuing an XMI request to the myAlerts service 301. The sender 500 can send alerts to the sender's own user, or to another user. Senders and most userAgents are clients because they issue XMI requests to the myAlerts service to send or receive alerts. Because myAlerts supports non-XMI protocols to deliver alerts to userAgents, some userAgents are not clients.

UserAgents 516-518 create connections 512-514, respectively, to receive alerts. Each connection (e.g., 512) has a query that selects which alerts the connection 512 will forward to its respective userAgent 516. The connection 512 will use a particular protocol to deliver alerts to the userAgent 516; different connection types may provide different protocols for a userAgent. As the NET Alerts service receives alerts, it routes them to zero or more connections, depending on the queries for each connection.

To send an alert 502, a client sender 500 issues a notify method request to a user's myAlerts service 301. To receive alerts, a userAgent (e.g., 516) issues an insert method request to create a connection 516 in the myAlerts content document, and then processes the resulting connection protocol to receive incoming alerts. Different connection types can support different alerts and userAgent protocols (for example, SOAP/XMI over HTTP, TCP/DIME, and UDP), and can also include SIP or other non-XMI protocols. Connections generally fall into Push Connections, wherein the myAlerts service proactively pushes an alert to a userAgent, or Pull Connections, wherein the userAgent proactively pulls an alert from the myalerts service. This requires some alert buffering.

In general, each alert 502 is a snippet of XML passed to and from the myAlerts service 301 embedded within XMI method request and response packets. The lifetime (and position) of an alert is transitory. Therefore, alerts are not part of the user content document. Alerts are proactively sent to the myAlerts service or to userAgents with the notify method, described below. Alerts are proactively pulled from the myalerts service with the poll method, also described below.

Argots 503 are XML blobs (e.g., strongly-named {any} fields) that may be placed in an alert to convey problem domain-specific data. The outer element name defines the argot; the inner contents of the argot are opaque to general myAlerts processing. At present, argots may be represented formally and informally. An argot is formally declared through an outer argot element, and its name is specified through the argotURI attribute. The actual content of the argot is specified in sub-elements. The formal representation of argots may change to the informal representation in future versions. Informally declared argots are simply declared as an XML element. In this case, the argot name is the name of that element. Such an argot can have sub-elements, as appropriate.

The myAlerts service expects informal argots within the contents element of an alert. The xpQuery element for both streams and connections defines a query against the argot names within the contents element. For example, an xpQuery value of “humanReadable” in a connection causes that connection to get only alerts that contain the humanReadable argot in their contents. To match all argots, an asterisk (“*”) may be specified in the xpQuery value.

The myAlerts service expects formal argots in some of the stream and connection document methods. For example, the push connection requires the pushConnectionParameters formal argot in insert and replace methods, and generates it for query methods.

As generally represented in FIG. 5, a streams model is also provided. Unlike the basic model, the streams model provides a mechanism to filter, buffer, persist, or intelligently control the routing of alerts. A stream of alerts is a set of alerts that match an argot query. The argot query specifies a relation of argot types; an alert is in the stream if it contains argots that match the stream query. To include alerts in a stream, an asterisk (“*”) may be used, or a set of argot types (for example, “humanReadable”) can be specified to include a subset.

A stream (e.g., 505) is an object inside a user's myAlerts service 301 that defines and manages a stream of alerts as they are routed to the user's connections. Clients can create and provision one or more streams to control the alert routing for a user. A user may have multiple streams 505-507 to control different streams of alerts. Multiple streams are supported because a user will often receive different types of alerts, each requiring its own filtering, buffering, and so on. For example, the myAlerts service 301 may focus on human-oriented alerts to implement a stream that controls alerts containing the humanReadable argot. Other services or applications will define their own argots, and will want to control the processing of their alerts.

Clients create, manage, and delete streams through XMI requests to a user's NET Alerts content document. Generally, a stream operates in four steps:

1. Instantiate—the stream is instantiated from a stream class and provisioned to control its behavior.

2. Select—the stream will select the alerts to process as they arrive.

3. Process—the stream processes its selected alerts.

4. Route—the stream routes its alerts to other streams or to connections for delivery to one or more userAgents.

These steps are formalized in three objects inside the alert routing, namely streamFork 504, stream (e.g., the stream 506) and connectionFork (510). When an alert 502 is received by the myAlerts service 301, the streamFork 504 decides the order in which to invoke streams 505-507 on the alert 502. When invoked, each stream will determine whether to handle the alert and whether to continue or stop the streamFork processing. A stream (e.g., the stream 506) can handle or ignore an alert, and can also allow or inhibit later streams from handling the alert.

Each of the streams 505-507 then applies its processing algorithm and state to the alerts they handle. A stream can reroute the alert to other streams by continuing or restarting the streamFork process. A stream can deliver an alert by passing it on to the connections through the connectionFork 510.

The connectionFork 510 controls communication between streams and connections 512-514, processing and optimizing execution of the connection queries to match alerts to the appropriate connections. Conceptually, as represented in FIG. 5, alerts (e.g., the alert 502) moves forward from the sender 500, through the streamFork 504, through zero or more streams 505-507, through the connectionFork 510, through zero or more connections 512-514, to connected userAgents 516-518. Streams 505-507 can push alerts to connections 512-514 or connections 512-514 can pull alerts from streams 505-507. This will match the type of connections (that is, push or pull).

Stream types provide different alert handling algorithms. Five possible stream capabilities includes:

1. Simple Stream—selects a set of alerts and immediately passes them to any/all connections. This is the default stream for myAlerts and is always implemented by the streamFork. It provides no buffering; alerts are immediately delivered through existing connections and then discarded. When they are not connected, userAgents miss all alerts.

2. Buffering Stream—selects a subset of alerts and buffers them for some period of time. Alerts are passed to a connection when the connection can process the alert. Stream buffering allows a connection to deliver alerts received before the connection was created or across delays and failures in the connection's protocol.

3. Privacy Stream—selects and filters a subset of alerts according to a set of privacy or safety rules. The stream will choose to discard or deliver an alert based on its rules. Typically, a privacy stream will take sole possession of its subset of alerts.

4. Routing Stream—selects a subset of alerts and changes their routing, controlling which succeeding streams or connections will process the alert. Routing streams can insert or remove alerts from the alert streams.

5. External Stream—delegates the actual stream algorithm and state to an object external to the myAlerts provider. The external stream type specifies and implements an XMI application programming interface (API) for the external object.

The myAlerts architecture declares the ordering and non-ordering of alert delivery through a connection. However, alert buffering, multiple streams, and intra-user federation can make it difficult to guarantee ordering, and arbitrary rerouting of alerts by routing streams can make ordering impossible. A virtual stream is the aggregate set of alerts delivered through a particular connection. The order in a virtual stream will be defined by the set of streams contributing alerts to the virtual stream. Simple, buffering, and privacy streams are required to maintain a standard ordering of oldest to newest alerts in a virtual stream. Routing and external streams are also required to maintain that order. Alerts that are inserted into the stream need to be new; an old alert cannot be reinserted out of order or multiple times.

One implementation of myAlerts provides a streamDefault stream class, which always exists and is not reflected in the user's content document, and a streamBuffer stream class. This stream will buffer up to one-hundred of the alerts it selects in memory. Note the number one-hundred is arbitrary, and was just selected as a suitable number for this implementation.

Two connection classes are implemented in one current implementation of myAlerts, namely a pushConnection, wherein the connection will push an alert to an URL by issuing an XMI notify method request, and a pullConnection, wherein the userAgent will issue XMI poll method requests to the connection to retrieve alerts.

The alert schema contains both standard and problem-domain specific portions. The present invention types the problem-domain portions as argots and allows that typing to define the essential semantic naming shared between alert senders and receivers.

The schema for the alert processing mechanism contains both stream objects which control alert processing within our service and connection objects which control delivery and protocol to external user agents. Both types of objects select and process alerts based on the argots contained in each alert, through the argotQuery element that specifies a standing query against received and persisted alerts.

In addition, new methods are provided, described below, including:

1. Notify—to transmit one or more alerts from a sender to a receiver

2. Poll—for a user agent to pull one or more alerts through a connection from our service

3. Route—to perform complex and privileged routing within our service

4. Do—to request a stream or connection object to perform an action

```
myAlerts/Roles
  The myAlerts service controls access by using the rt0, rt3 and rt99
  roleTemplates,
using the following scopes:
  scope allElements
  <hs:scope id=7215df55-e4af-449f-a8e4-72a1f7c6a987>
    <hs:shape base=t>
    </hs:shape>
  </hs:scope>
  scope onlySelfElements
  <hs:scope id=a159c93d-4010-4460-bc34-5094c49c1633>
    <hs:shape base=nil>
      <hs:include select=//*[@creator=‘$callerId’]/>
    </hs:shape>
  </hs:scope>
  scope onlySelfSubscriptionElements
  <hs:scope id=b7f05a6d-75cd-4958-9dfb-f532ebb17743>
    <hs:shape base=nil>
      <hs:include select=//subscription[@creator=‘$callerId’]/>
    </hs:shape>
  </hs:scope>
  scope onlyPublicElements
  <hs:scope id=da025540-a0c0-470f-adcf-9f07e5a5ec8f>
    <hs:shape base=nil>
      <hs:include select=//*[cat/@ref=‘hs:public’]/>
      <hs:include select=//subscription[@creator=‘$callerId’]/>
    </hs:shape>
  </hs:scope>
```

The myalerts roleTemplate rt0 role gives complete read/write access to the information within the content document of the service being protected through this roleTemplate. The following table illustrates the available methods and the scope in effect when accessing the myAlerts service through that method while mapped to this roleTemplate:

TABLE
myAlerts roleTemplate rt0

| method | scope/name |
|---|---|
| query | allElements |
| insert | allElements |
| replace | allElements |
| delete | allElements |
| update | allElements |
| update | allElements |
| notify | allElements |
| poll | allElements |

The myAlerts roleTemplate rt3 role gives limited read access to information within the content document that is categorized as “public”. Applications mapping to this role have very limited write access and are only able to create and manipulate their own subscription nodes. The following table illustrates the available methods and the scope in effect when accessing the myAlerts service through that method while mapped to this roleTemplate:

TABLE
myAlerts roleTemplate rt3

| method | scope/name |
|---|---|
| query | onlyPublicElements |
| Notify | allElements |

The myalerts roleTemplate rt99 blocks access to the content document. Note that lack of a role in the roleList has the same effect as assigning someone to rt99.

myAlerts/notification

Each alert comprises XML embedded within an XMI method packet or privately stored by the .NET Alerts service. The following is the structure of an alert:

```
<m:notification id=“...”
  xmlns:m=“http://schemas.microsoft.com/hs/2001/10/myAlerts”
  xmlns:hs=“http://schemas.microsoft.com/hs/2001/10/core”>_{0..unbounded}
  <m:from>_{1..1}
    <m:identityHeader type=“...”>_{0...1}
      <m:onBehalfOfUser>_{1..1}</m:onBehalfOfUser>
      <m:licenseHolder>_{1..1}</m:licenseHolder>
      <m:platformId>_{1..1}</m:platformId>
    </m:identityHeader>
    <m:expiresAt ttl=“...” onDate=“...” replace=“...” >_{0..1}</m:expiresAt>
    <m:acknowledge>_{0..1}</m:acknowledge>
    <m:category id=“...”>_{0..1}</m:category>
  </m:from>
  <m:to>_{0..1}
    <m:originalUser>_{0..1}</m:originalUser>
  </m:to>
  <m:contents>_{1..1} {any}</m:contents>
  <m:routing>_{1..1}
    <m:timestamp>_{0..1}</m:timestamp>
    <m:hops>_{0..1}</m:hops>
  </m:routing>
</m:notification>
```

The /notification (minOccurs=0 maxOccurs=unbounded) provides for zero or more alerts in the buffer of the streamBuffer stream. The /notification/@id (string minOccurs=0 maxOccurs=1) is an identifier of the alert (notification), while the /notification/from (minOccurs=1 maxOccurs=1) tag contains data from the sender, including sender authentication as well as preferences and requests from the sender.

The /notification/from/identityHeader (minOccurs=0maxOccurs=1) includes /notification/from/identityHeader/@type (string minOccurs=0 maxOccurs=1) and /notification/from/identityHeader/onBehalfOftJser (minOccurs=1 maxOccurs=1). The uuidType is used to specify a universally unique identifier (UUID). The /notification/from/identityHeader/licenseHolder (minOccurs=maxOccurs=1) uuidType is used to specify a universally unique identifier (UUID).

The /notification/from/identityHeader/platformId (minOccurs=1 maxOccurs=1) uuidType is used to specify a universally unique identifier (UUID). The /notification/from/expiresAt (string minOccurs=0 maxOccurs=1) is directed to expiration time of an alert, including /notification/from/expiresAt/@ttl (string minOccurs=0 maxOccurs=1), /notification/from/expiresAt/@onDate (string minOccurs=0 maxOccurs=1) and /notification/from/expiresAt/@replace (string minOccurs=0 maxOccurs=1).

The /notification/from/acknowledge (string minOccurs=0 maxOccurs=1) field contains information related to acknowledging the alert, while /notification/from/category (minOccurs=0 maxOccurs=1) and /notification/from/category/@id (string minOccurs=0 maxOccurs=1) contains category information.

The /notification/to (minOccurs=0 maxOccurs=1) tag contains the data pertaining to the receiver. This data can be set by the sender or by any processing/routing agent between the sender and the receiver. The /notification/to/originalUser (minOccurs=0 maxOccurs=1) element defines the original receiver of the alert. A routing agent may change (forward or fan out) an alert to other receivers. If so, it should add this element to the alert.

The /notification/contents (minOccurs 1 maxOccurs=1) element contains the problem domain-specific data to be conveyed to the receiver. Each child element of the contents element is an argot, a problem domain-specific strongly-typed XML blob. Streams and connections query against the element names of these blobs when selecting alerts they will process. The /notification/contents/{any} (minOccurs=0 maxOccurs=unbounded) contains the argot data.

The /notification/routing (minOccurs=1 maxOccurs=1) tag contains any routing data 10 inserted by the-myAlerts routing process. The !notification/routing/timestamp (string minOccurs=0 maxOccurs=1) element contains the timestamp of when the alert was received by the myalerts service. The /notification/routing/hops (string minOccurs=0 maxOccurs=1) element defines the actors that have processed the alert to date. This data can be used by the myalerts service to recognize and stop infinite loops.

```
myAlerts/content
<m:myAlerts changeNumber=“...” instanceId=“...”
  xmlns:m=“http://schemas.microsoft.com/hs/2001/10/myAlerts”
  xmlns:hs=“http://schemas.microsoft.com/hs/2001/10/core”>_{1..1}
    <m:stream changeNumber=“...” id=“...” creator=“...”>_{1..unbounded}
    <m:class>_{1..1}</m:class>
    <m:expiration>_{0..1} </m:expiration>
    <m:position>_{1..1}</m:position>
    <m:argotQuery>_{0..1}</m:argotQuery>
    <m:argot argotURI=“...”>_{0..unbounded} {any}</m:argot>
  </m:stream>
  <m:connection changeNumber=“...” id=“...” creator=“...”>_{0..unbounded}
    <m:class>_{1..1}</m:class>
    <m:status>_{1..1}</m:status>
    <m:characteristics>_{1..1}</m:characteristics>
    <m:expiration>_{1..1}</m:expiration>
    <m:argotQuery>_{1..1}</m:argotQuery>
    <m:argot argotURI=“...”>_{0..unbounded} {any}</m:argot>
  </m:connection>
  <m:subscription changeNumber=“...” id=“...” creator=“...”>_{0..unbounded}
    <hs:trigger select=“...” mode=“...” baseChangeNumber=
    “...”>_{1..1}</hs:trigger>
    <hs:expiresAt>_{0..1}</hs:expiresAt>
    <hs:context uri=“...”>_{1..1} {any}</hs:context>
    <hs:to>_{1..1}</hs:to>
  </m:subscription>
</m:myAlerts>
```

The myAlerts content document comprises the user content document for alert routing. It contains streams, connections, and preferences (general provisioning). The document does not contain a list of alerts, as alerts are transitory. NotifyRequest, route, and PollRequest are used to send and receive alerts, as described below.

The /myAlerts/@(changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myAlerts/@instanceId (string minOccurs=0 maxOccurs=1) attribute is a unique identifier typically assigned to the root element of a service. It is a read-only element and assigned by the .NET My Services system when a particular service is provisioned for a user.

The /myAlerts/stream (minOccurs=1 maxOccurs=unbounded) is directed to a stream, which comprises an internal object that processes alerts before they are routed to connections. Streams can buffer or reroute. The /myAlerts/stream/@changeNumber (minOccurs=1 maxOccurs=1) changeNumber attribute is designed to facilitate caching of the element and its descendants. This attribute is assigned to this element by the NET My Services system. The attribute is read only to applications. Attempts to write this attribute are silently ignored. The /myAlerts/stream/@id (minOccurs=1 maxOccurs=1) attribute is a globally unique ID assigned to this element by .NET My Services. Normally, NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myAlerts/stream/@creator (minOccurs=maxOccurs=1) attribute identifies the creator in terms of userId, appId, and platformId of the node. The /myAlerts/stream/class (string minOccurs=1 maxOccurs=1) defines what kind of stream this is. The /myAlerts/stream/expiration (dateType minOccurs=0 maxOccurs=1) specifies the lifetime of a connection in absolute time (GMT). This can be used to clean up the content document. The /myAlerts/stream/position (string minOccurs=1 maxOccurs=1) defines where the stream fits into the streamFork processing.

The /myAlerts/stream/argotQuery (string minOccurs=0 maxOccurs=1) field maintains the stream's query against incoming alerts. The query specifies the argot name(s) that enable selection (a logical OR of the named argots). This is optional based on the streamClass (e.g., a stream may do its own selection processing instead of or in addition to the standard stream alert query). If not present, the query defaults to all alert argots (“*”)

The /myAlerts/stream/argot (minOccurs=0 maxOccurs=unbounded) field comprises an optional provisioning argot for the stream, and is dependent on the stream class. The /myAlerts/stream/argot/@largotURI (anyURI minOccurs=1 maxOccurs=1) URI uniquely identifies the type of argot and points to a location containing the XSD for this argot. The /myAlerts/stream/argot/{any} (minOccurs=0 maxOccurs=unbounded) field contains argot data.

The /myAlerts/connection (minOccurs=0 maxOccurs=unbounded) uses the following abbreviations: CXN (for a connection, which exists inside of the .NET Alerts service as described above with reference to FIG. 5), and UA (for a UserAgent, which exists outside of the .NET Alerts service). There are two primary types of connections, namely push, wherein alerts are pushed by CXN to UA, and pull, wherein alerts are downloaded by the UA by issuing a request to CXN. The response contains the alerts. A CXN is created (added to the .NET Alerts content document) either by the UA directly or by some entity acting on behalf of the UA. In order to transfer the alerts, a session, either persistent or transient, is established between CXN and UA. In cases in which sessions are transient, the CXN persists. Establishment of a session can be initiated by a CXN or the UA, when the CXN is created or based on, for example, a timer or some signaling mechanism between CXN and UA. The session can be closed by either entity after a period of time (including 0). The following are different models of UA-CXN interaction: 1) UA establishes a session with a CXN and pulls alerts from CXN; 2) UA establishes a session with a CXN and the CXN pushes alerts to the UA; 3) CXN establishes a session with a UA and the UA pulls alerts; 4) CXN establishes a session with a UA and pushes alerts to UA; 5) UA polls the CXN periodically on a timer and UA will initiate process 1) or 2); and 6) CXN polls the UA when alerts arrive or periodically on a timer. When there are pending alerts in the queue, UA will initiate process 1) or 2).

The /myAlerts/connection/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myAlerts/connection/lid (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myAlerts/connection/@creator (minOccurs=1 maxOccurs=1) attribute identifies the creator in terms of userId, appId, and platformId of the node. The /myAlerts/connection/class (string minOccurs=1 maxOccurs=1) element specifies the class of a connection (for example, Push over Soap-RP or Pull over Soap-RP).

The /myAlerts/connection/status (string minOccurs=1 maxOccurs=1) contains flags indicating the current status of the connection. This can be used by the Stream modules to do traffic management, buffering, generate non-delivery and delayed delivery reports for the sender. The /myAlerts/connection/characteristics (string minOccurs=1 maxOccurs=1) field contains information about the nature of the connection, used mainly by the Stream modules. Reliable can mean it supports ACKs, while unreliable means it is fire-and-forget. Characteristics may include the type of polling used (Connection vs. UserAgent).

The /myAlerts/connection/expiration (dateType minOccurs=1 maxOccurs=1) field contains the lifetime of a connection in absolute time (GMT). This can be used to clean up the content document. The /myAlerts/connection/argotQuery (string minOccurs=1 maxOccurs=1) field maintains the connection's query against incoming alerts. The query specifies the argot name(s) that enable selection (a logical OR of the named argots).

The /myAlerts/connection/argot (minOccurs=0 maxOccurs=unbounded) contains an optional provisioning argot for the connection. This is dependent on the connection class. The /myAlerts/connection/argot/@argotURI (anyURI minOccurs=1 maxOccurs=1) URI uniquely identifies the type of argot and points to a location containing the XSD for this argot. The /myAlerts/connection/argot/{any} (minOccurs=0 maxOccurs=unbounded) contains the argot data.

myAlerts—Domain-Specific Methods

The myAlerts service uses the standard methods, and domain-specific methods notify and poll. The notify method allows a client to send an alert to the userAgents connected for the user. The poll method allows a userAgent to proactively pull an alert through a connection.

The myAlerts/notify Method sends one or more alerts to the receiver. If the receiver is the .NET Alerts service, the alert(s) will be delivered to the appropriate set of connected userAgents. The myAlerts/notifyRequest method is accessed using a request message, and in response may generate a response message or a SOAP Fault message. The following sample document fragments illustrate the structure and meaning of the elements and attributes in the request and response messages.

The following table and accompanying description thereafter describes the request message for this method:

```
<m:notifyRequest
  xmlns:m=“http://schemas.microsoft.com/hs/2001/10/myAlerts”
  xmlns:hs=“http://schemas.microsoft.com/hs/2001/10/core”>_{1..1}
  <m:notification id=“...”>_{0..unbounded}
    <m:from>_{1..1}
      <m:identityHeader type=“...”>_{0..1}
        <m:onBehalfOfUser>_{1..1}</m:onBehalfOfUser>
        <m:licenseHolder>_{1..1}</m:licenseHolder>
        <m:platformId>_{1..1}</m:platformId>
      </m:identityHeader>
      <m:expiresAt ttl=“...” onDate=“...” replace=“...”>_{0..1}</m:
      expiresAt>
      <m:acknowledge>_{0..1}</m:acknowledge>
      <m:category id=“...”>_{0..1}</m:category>
    </m:from>
    <m:to>_{0..1}
      <m:originalUser>_{0..1}</m:originalUser>
    </m:to>
    <m:contents>_{1..1} {any}</m:contents>
    <m:routing>_{1..1}
      <m:timestamp>_{0..1}</m:timestamp>
      <m:hops>_{0..1}</m:hops>
    </m:routing>
  </m:notification>
</m:notifyRequest>
```

The /notifyRequest (minOccurs=1 maxOccurs=1) method attempts to send the enclosed alerts using standard routing by .NET Alerts. There can be one or more notification elements specified. If none is specified, the notify request should be interpreted as a query about whether the receiver is willing to accept alerts from this sender. The /notifyRequest/notification (minOccurs=0 maxOccurs=unbounded) specifies an alert to be delivered. The /notifyRequest/notification/@id (string minOccurs=0 maxOccurs=1) and /notifyRequest/notification/from (minOccurs=1 maxOccurs=1) tag contains all data from the sender, including sender authentication as well as preferences and requests from the sender.

The /notifRequest/from/identityHeader (minOccurs=0 maxOccurs=1) includes /notifyRequest/from/identityHeader/@(type (string minOccurs=0 maxOccurs=1) and /notifyRequest/from/identityHeader/onBehalfOfUser (minOccurs=1 maxOccurs=1). The uuidType is used to specify a universally unique identifier (UUID). The /notifyRequest/from/identityHeader/licenseHolder (minOccurs=1maxOccurs=1) uuidType is used to specify a universally unique identifier (UUID).

The /notifyRequest/from/identityHeader/platformId (minOccurs=1 maxOccurs=1) uuidType is used to specify a universally unique identifier (UUID). The /notifyRequest/from/expiresAt (string minOccurs=0 maxOccurs=1) is directed to expiration time of an alert, including /notifyRequest/from/expiresAt/@ttl (string minOccurs=0 maxOccurs=0), /notifyRequest/from/expiresAt/@onDate (string minOccurs=0 maxOccurs 1) and /notifyRequest/from/expiresAt/@replace (string minOccurs=0 maxOccurs=1).

The /notifyRequest/from/acknowledge (string minOccurs=0 maxOccurs=1) field contains information related to acknowledging the alert, while /notifyRequest/from/category (minOccurs=0 maxOccurs=1) and /notifyRequest/from/category/@id (string minOccurs=0 maxOccurs=1) contains category information.

The /notifyRequest/to (minOccurs=0 maxOccurs=1) tag contains the data pertaining to the receiver. This data can be set by the sender or by any processing/routing agent between the sender and the receiver. The /notifyRequest/to/originalUser (minOccurs=0 maxOccurs=1) element defines the original receiver of the alert. A routing agent may change (forward or fan out) an alert to other receivers. If so, it should add this element to the alert.

The /notifyRequest/contents (minOccurs=1 maxOccurs=1) element contains the problem domain-specific data to be conveyed to the receiver. Each child element of the contents element is an argot, a problem domain-specific strongly-typed XML blob. Streams and connections query against the element names of these blobs when selecting alerts they will process. The /notifyRequest/contents/{any} (minOccurs=0 maxOccurs=unbounded) contains the argot data.

The /notifyRequest/routing (minOccurs=1 maxOccurs=1) tag contains any routing data inserted by the myAlerts routing process. The /notifyRequest/routing/timestamp (string minOccurs=0 maxOccurs=1) element contains the timestamp of when the alert was received by the myAlerts service. The /notifyRequest/routing/hops (string minOccurs=0 maxOccurs=1) element defines the actors that have processed the alert to date. This data can be used by the myAlerts service to recognize and stop infinite loops.

If the method causes a failure response to be generated, the failure is noted by generation of a SOAP Fault message. Failures can include a failure to understand a header marked as “s:mustUnderstand”, a NET My Services standard error, security violation, load-balance redirect, or any service-specific severe error condition.

The myAlerts/poll Method poll method can be used on a connection in NET Alerts to retrieve alerts that satisfy the xpQuery specified for the connection. Succeeding poll methods on a connection will return alerts in a first-in (received), first-out (delivered) order for that connection. Alerts will be buffered (that is, stored in the .NET Alerts service after receipt and later delivered by a poll method invocation) only if a suitable buffering stream has been configured.

The myAlerts/pollRequest method is accessed using a request message, and in response may generate a response message or a SOAP Fault message. The following table and accompanying description thereafter describes the request message for this method:

```
m:pollRequest
    xmlns:m=“http://schemas.microsoft.com/hs/2001/10/myAlerts”
    xmlns:hs=“http://schemas.microsoft.com/hs/2001/10/core”>_{1..1}
    <m:parkInterval>_{0...1}</m:parkInterval>
</m:pollRequest>
```

The /pollRequest (minOccurs=1 maxOccurs=1) method can be invoked on a connection. If there is a new alert in the buffer stream, it will be returned in the poltResponse message. The pollRequest will immediately return a response about whether there is a pending alert. However, if the optional parkInterval element is specified, then the response can take up to parkinterval milliseconds before returning when there are no new alerts in the buffer stream. The /pollRequest/parkInterval (string minOccurs=0 maxOccurs=1) field specifies the time, wherein the unit of time for parkInterval is milliseconds.

Upon successful completion of this method, a response message, myAlerts/polIResponse, is generated. The format of the response message is described below, wherein the number of alerts returned in the response can be zero or one:

```
<m:pollResponse
  xmlns:m=“http://schemas.microsoft.com/hs/2001/10/myAlerts”
  xmlns:hs=“http://schemas.microsoft.com/hs/2001/10/core”>_{1..1}
  <m:notification id=“...”>_{0...1}
    <m:from>_{1..1}
      <m:identityHeader type=“...”>_{0...1}
        <m:onBehalfOfUser>_{1..1}</m:onBehalfOfUser>
        <m:licenseHolder>_{1..1}</m:licenseHolder>
        <m:platformId>_{1..1}</m:platformId>
      </m:identityHeader>
      <m:expiresAt ttl=“...” onDate=“...” replace=“...”>_{0...1}</m:
      expiresAt>
      <m:acknowledge>_{0...1}</m:acknowledge>
      <m:category id=“...”>_{0...1}</m:category>
    </m:from>
    <m:to>_{0...1}
      <m:originalUser>_{0..1}</m:originalUser>
    </m:to>
    <m:contents>_{1..1} {any}</m:contents>
    <m:routing>_{1..1}
      <m:timestamp>_{0...1}</m:timestamp>
      <m:hops>_{0...1}</m:hops>
    </m:routing>
  </m:notification>
</m:pollResponse>
```

The /pollResponse (minOccurs=1 maxOccurs=1) response contains zero or one new alerts in the buffer stream. The /polIResponse/notification (minOccurs=0 maxOccurs=1) comprises a new alert contained in the buffer stream. The /pollResponse/notification/@id (string minOccurs=0 maxOccurs=1) contains an identifier

The /pollResponse/notification/from (minOccurs=1 maxOccurs=1) tag contains data from the sender, including sender authentication as well as preferences and requests from the sender. The /pollResponse/from/identityHeader (minOccurs=0 maxOccurs=1) includes /pollResponse/from/identityHeader/@type (string minOccurs=0 maxOccurs=1) and /pollResponse/from/identityHeader/onBehalfOftJser (minOccurs=1 maxOccurs 1). The uuidType is used to specify a universally unique identifier (UUID). The /pollResponse/from/identityHeader/licenseHolder (minOccurs=1 maxOccurs=1) uuidType is used to specify a universally unique identifier (UUID).

The /pollResponse/from/identityHeader/platformId (ninOccurs=1 maxOccurs=1) uuidType is used to specify a universally unique identifier (UUID). The /polIResponse/from/expiresAt (string minOccurs=0 maxOccurs=1) is directed to expiration time of an alert, including /polIResponse/from/expiresAt/@ttl (string minOccurs=0 maxOccurs=1), /pollResponse/from/expiresAt/@onDate (string minOccurs=0 maxOccurs=1) and /pollResponse/from/expiresAt/@replace (string minOccurs=0 maxOccurs=1).

The /pollResponse/from/acknowledge (string minOccurs=0 maxOccurs=1) field contains information related to acknowledging the alert, while /pollResponse/from/category (minOccurs=0 maxOccurs=1) and /pollResponse/from/category/@id (string minOccurs=0 maxOccurs=1) contains category information.

The /pollResponse/to (minOccurs=0 maxOccurs 1) tag contains the data pertaining to the receiver. This data can be set by the sender or by any processing/routing agent between the sender and the receiver. The/pollResponse/to/originalUser (minOccurs=0 maxOccurs=1) element defines the original receiver of the alert. A routing agent may change (forward or fan out) an alert to other receivers. If so, it should add this element to the alert.

The /pollResponse/contents (minOccurs=1 maxOccurs=1) element contains the problem domain-specific data to be conveyed to the receiver. Each child element of the contents element is an argot, a problem domain-specific strongly-typed XML blob. Streams and connections query against the element names of these blobs when selecting alerts they will process. The /pollResponse/contents/{any} (minOccurs=0 maxOccurs=unbounded) contains the argot data.

The /pollResponse/routing (minOccurs=1 maxOccurs=1) tag contains any routing data inserted by the myAlerts routing process. The /pollResponse/routing/timestamp (string minOccurs=0 maxOccurs=1) element contains the timestamp of when the alert was received by the myAlerts service. The /polIResponse/routing/hops (string minOccurs=0 maxOccurs=1) element defines the actors that have processed the alert to date. This data can be used by the myAlerts service to recognize and stop infinite loops.

The myAlerts/humanReadable Notification Argot (the humanReadable argot) defines the standard XML schema to convey alert data that should be displayed to human beings to the userAgents:

```
<m:humanReadable
    xmlns:m=“http://schemas.microsoft.com/hs/2001/10/myAlerts”
    xmlns:hs=“http://schemas.microsoft.com/hs/2001/10/core”>_{1..1}
    <m:baseUrl>_{1..1}</m:baseUrl>
    <m:actionUrl>_{1..1}</m:actionUrl>
    <m:subscriptionUrl>_{1..1}</m:subscriptionUrl>
    <m:language xml:lang=“...” iconUrl=“...”>_{1..unbounded}
        <m:text>_{1..1}</m:text>
    </m:language>
</m:humanReadable>
```

The /humanReadable (minOccurs=1 maxOccurs=1) element is an argot used to convey human readable information in an alert. The receiver of a human readable alert should be able, at a minimum, to display the text element data to a human in either textual or speech form. The /humanReadable/baseUrl (anyURI minOccurs=1 maxOccurs=1) comprises a base URL to which all other URLs are relative.

The /humanReadable/actionUrl (anyURI minOccurs=1 maxOccurs=1) comprises a URL that links to an action page from the sender. This URL can be relative to the baseURL element. The /humanReadable/subscriptionUrl (anyURI minOccurs=1 maxOccurs=1) comprises a URL that links to the sender's page to allow the receiver to view and change the way the alert was sent. This URL can be relative to the baseURL element.

The /humanReadable/language (minOccurs=1 maxOccurs=unbounded) element contains text specific to a language. As many language elements as desired can be included to convey the same information in different languages. The /humanReadable/language/@xml:lang (minOccurs=1 maxOccurs=1) required attribute is used to specify an ISO 639 language code or an ISO 3166 country code as described in RFC 1766. The value of this attribute indicates the language type of the content within this element. The /humanReadable/language/@iconUrl (anyURI minOccurs=0 maxOccurs=1) attribute contains an optional URL from the sender for an icon in a Portable Network Graphics (PNG) file that can be used when the userAgent displays the content to the user. The /humanReadable/language/text (string minOccurs=1 maxOccurs=1) element contains the text to be conveyed to the human. This text is in the language specified by the xml:lang attribute.

The myAlerts/bufferStreamParameters provisioning argot (the bufferStreamParameters argot) defines the data returned by a query from a streamBuffer:

```
<m:bufferStreamParameters
  xmlns:m=“http://schemas.microsoft.com/hs/2001/10/myAlerts”
  xmlns:hs=“http://schemas.microsoft.com/hs/2001/10/core”>_{1..1}
  <m:notification id=“...”>_{0..unbounded}
    <m:from>_{1..1}
      <m:identityHeader type=“...”>_{0...1}
        <m:onBehalfOfUser>_{1..1}</m:onBehalfOfUser>
        <m:licenseHolder>_{1..1}</m:licenseHolder>
        <m:platformId>_{1..1}</m:platformId>
      </m:identityHeader>
      <m:expiresAt ttl=“...” onDate=“...” replace=“...”>_{0...1}</m:
      expiresAt>
      <m:acknowledge>_{0...1}</m:acknowledge>
      <m:category id=“...”>_{0...1}</m:category>
    </m:from>
    <m:to>_{0...1}
      <m:originalUser>_{0...1}</m:originalUser>
    </m:to>
    <m:contents>_{1..1}{any}</m:contents>
    <m:routing>_{1..1}
      <m:timestamp>_{0...1}</m:timestamp>
      <m:hops>_{0...1}</m:hops>
    </m:routing>
  </m:notification>
</m:bufferStreamParameters>
```

The /bufferStreamParameters (minOccurs=1 maxOccurs=1) element comprises an argot specifying the read and write parameters for a bufferStream stream. For one current implementation of .NET My Services, the bufferStream takes no input parameters; it returns the current set of buffered alerts through this argot. A query on a bufferStream is a transient, read-only operation. The/bufferStreamParameters/notification (minOccurs=0 maxOccurs=unbounded) is directed to zero or more alerts in the buffer of the streamBuffer stream.

The /bufferStreamParameters/notification (minOccurs=0 maxOccurs=1) comprises a new alert contained in the buffer stream. The /bufferStreamParameters/notification/@id (string minOccurs=0 maxOccurs=1) contains an identifier

The /bufferStreamParameters/notification/from (minOccurs=1 maxOccurs=1) tag contains data from the sender, including sender authentication as well as preferences and requests from the sender. The /bufferStreamParameters/from/identityHeader (minOccurs=0 maxOccurs 1) includes /bufferStreamParameters/from/identityHeader/@type (string minOccurs=0 maxOccurs=1) and /bufferStreamParameters/from/identityHeader/onBehalfOfUser (minOccurs=1 maxOccurs=1). The uuidType is used to specify a universally unique identifier (UUID). The /bufferStreamParameters/from/identityHeader/licenseHolder (minOccurs=1 maxOccurs=1) uuidType is used to specify a universally unique identifier (UUID).

The /bufferStreamParameters/from/identityHeader/platformId (minOccurs=1 maxOccurs=1) uuidType is used to specify a universally unique identifier (UUID). The /bufferStreamParameters/from/expiresAt (string minOccurs=0 maxOccurs=1) is directed to expiration time of an alert, including /bufferStreamParameters/from/expiresAt/@ttl (string minOccurs=0 maxOccurs=1), /bufferStreamParameters/from/expiresAt/@onDate (string minOccurs=0 maxOccurs=1) and /bufferStreamParameters/from/expiresAt/@replace (string minOccurs=0 maxOccurs=1).

The /bufferStreamParameters/from/acknowledge (string minOccurs=0 maxOccurs=1) field contains information related to acknowledging the alert, while /bufferStreamParameters/from/category (minOccurs=0 maxOccurs=1) and /bufferStreamParameters/from/category/@id (string minOccurs=0 maxOccurs=1) contains category information.

The /bufferStreamParameters/to (minOccurs=0 maxOccurs=1) tag contains the data pertaining to the receiver. This data can be set by the sender or by any processing/routing agent between the sender and the receiver. The /bufferStreamParameters/to/originalUser (minOccurs=0 maxOccurs=1) element defines the original receiver of the alert. A routing agent may change (forward or fan out) an alert to other receivers. If so, it should add this element to the alert.

The /bufferStreamParameters/contents (minOccurs=1 maxOccurs=) element contains the problem domain-specific data to be conveyed to the receiver. Each child element of the contents element is an argot, a problem domain-specific strongly-typed XML blob. Streams and connections query against the element names of these blobs when selecting alerts they will process. The /bufferStreamParameters/contents/{any} (minOccurs=0 maxOccurs=unbounded) contains the argot data.

The /bufferStreamParameters/routing (minOccurs=1 maxOccurs=1) tag contains any routing data inserted by the myalerts routing process. The /bufferStreamParameters/routing/timestamp (string minOccurs=0 maxOccurs 1) element contains the timestamp of when the alert was received by the myAlerts service. The /bufferStreamParameters/routing/hops (string minOccurs=0 maxOccurs=1) element defines the actors that have processed the alert to date. This data can be used by the myAlerts service to recognize and stop infinite loops.

The myAlerts/pushConnectionParameters Provisioning Argot (pushConnectionParameters argot) defines the data passed to and returned from connectionPush:

```
<m:pushConnectionParameters
    xmlns:m=“http://schemas.microsoft.com/hs/2001/10/myAlerts”
    xmlns:hs=“http://schemas.microsoft.com/hs/2001/10/core”>_{1..1}
    <m:targetUrl>_{1..1}</m:targetUrl>
</m:pushConnectionParameters>
```

The /pushConnectionParameters (minOccurs=1 maxOccurs=1) element comprises an argot specifying the read and write parameters for a connectionPush connection. The /pushConnectionParameters/targetUrl (string minOccurs=1 maxOccurs=1) contains a target URL; the push connection will issue notifyRequest packets to this target URL.

NET Alerts (MyAlerts)/System

The system document is a global document for each service, having content and meaning that is independent of the puid used to address the service. The document is read only to all users. Each system document contains a set of base items common to each of the .NET My Services described herein, and is optionally extended by each service to include service-specific global information. The following schema outline illustrates the layout and meaning of the information found in the myAlerts system document:

TABLE
/MyAlerts/ system

```
<sys:system changeNumber=“...” instanceId=“...”
  xmlns:hs =“http://schemas.microsoft.com/hs/2001/10/core”
  xmlns:sys=“http://schemas.microsoft.com/hs/2001/10The /MyAlerts/system”>_{1..1}
  <hs:systemVersion changeNumber=“...” id=“...” creator=“...”>_{1..1}
    <hs:version majorVersion=“...” minorVersion=“...” buildNumber=“...” qfe=“...”>_{1..1}
      <hs:productReleaseName>_{1..1}</hs:productReleaseName>
      <hs:productImplementationName>_{1..1}</hs:productImplementationName>
    </hs:version>
    <hs:buildDate>_{1..1}</hs:buildDate>
    <hs:buildDetails machine=“...” branch=“...” type=“...” official=“...”>_{1..1}</hs:buildDetails>
  </hs:systemVersion>
  <hs:roleMap changeNumber=“...” id=“...” creator=“...”>_{1..1}
    <hs:scope id=“...”>_{0..unbounded}
      <hs:name xml:lang=“...” dir=“...”>_{0..unbounded}</hs:name>
      <hs:shape base=“...”>_{1..1}
        <hs:include select=“...”>_{0..unbounded}</hs:include>
        <hs:exclude select=“...”>_{0..unbounded}</hs:exclude>
      </hs:shape>
    </hs:scope>
    </hs:roleTemplate name=“...” priority=“...”>_{0..unbounded}
      <hs:fullDescription xml:lang=“...” dir=“...”>_{0..1}</hs:fullDescription>
      <hs:method name=“...” scopeRef=“...”>_{0..unbounded}</hs:method>
    </hs:roleTemplate>
  </hs:roleMap>
  <hs:methodMap changeNumber=“...” id=“...” creator=“...”>_{1..1}
    <hs:method name=“...”>_{0..unbounded} {any}</hs:method>
  </hs:methodMap>
  <hs:schemaMap changeNumber=“...” id=“...” creator=“...”>_{1..1}
    <hs:schema namespace=“...” schemaLocation=“...” alias=“...”>_{0..unbounded} {any}</hs:
    schema>
  </hs:schemaMap>
  <hs:wsdlMap changeNumber=“...” id=“...” creator=“...”>_{1..1}
    <hs:wsdl wsdlLocation=“...”>_{0..unbounded} {any}</hs:wsdl>
    <hs:disco discoLocation=“...”>_{0..unbounded} {any}</hs:disco>
    <hs:wsil wsilLocation=“...”>_{0..unbounded} {any}</hs:wsil>
  </hs:wsdlMap>
  </any>
</sys:system>
```

The meaning of the attributes and elements shown in the preceding sample document outline follow, beginning with /system (minOccurs=1 maxOccurs=1), the element that encapsulates a system document common to the various services. Although each service has its own system document, the common system document attributes and elements are described once, for purposes of simplicity, with service-specific system document attributes and elements specified for each service, below. The /system/@changeNumber (minOccurs=0 maxOccurs=1) attribute is designed to facilitate caching of the element and its descendants. This attribute is assigned to this element by the .NET My Services system. The attribute is read-only to applications. Attempts to write this attribute are silently ignored.

The /system/@instanceId (string minOccurs=0 maxOccurs=1) attribute is a unique identifier typically assigned to the root element of a service. It is a read-only element and assigned by the .NET My Services system when a user is provisioned for a particular service.

The /system/systemVersion (minOccurs=1 maxOccurs=1) element defines version information describing this instance of the .NET MyServices service. The /systemVersion/(changeNumber (minOccurs=0 maxOccurs=1) changeNumber attribute is designed to facilitate caching of the element and its descendants. This attribute is assigned to this element by the .NET My Services system. The attribute is read-only to applications; attempts to write this attribute are silently ignored, (e.g., without generating an error).

The /system/systemVersion/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/systemVersion/@creator (string minOccurs=0 maxOccurs=1) attribute identifies the creator in terms of userId, appId, and platformId of the node. The /system/systemVersion/version (minOccurs=1 maxOccurs=1) element defines major, minor, and build number version information. The /system/systemVersion/version/@(majorVersion (string minOccurs=0 maxOccurs=1) attribute specifies the major version number of the NET MyServices service.

The /system/systemVersion/version/@minorVersion (string minOccurs=0 maxOccurs=1) attribute specifies the minor version number of the .NET MyServices service. The /system/systemVersion/version/@buildNumber (string minOccurs=0 maxOccurs=1) attribute specifies the buildNumber of the .NET MyServices service. The /system/systemVersion/version/(qfe (string minOccurs=0 maxOccurs=1) attribute specifies the qfe version number of the NET MyServices service. The /system/systemVersion/version/productReleaseName (string minOccurs=1 maxOccurs=1) element defines the major product release string (as in .NET My Services Beta 1, and so on). The/system/systemVersion/version/productImplementationName (anyURI minOccurs=1 maxOccurs=1) element defines the class of the service to differentiate between different implementations.

The /system/systemVersion/buildDate (dateTime minOccurs=1 maxOccurs=1) element defines the date and time that the .NET My Services system was built. The time is in UTC (Z relative) form. The /systemVersion/buildDetails (minOccurs=1 maxOccurs=1) element defines details of the build including the machine that generated the build, the branch id of the software that contributed to the build, the type of build (chk/fre), and if the build was generated by an official build release process.

The /system/systemVersion/buildDetails/@machine (string minOccurs=0 maxOccurs=1) attribute specifies the machine that generated the build. The system/systemVersion/buildDetails/@branch (string minOccurs=0 maxOccurs=1) attribute specifies the software branch id for the source code that contributed to this build. The /system/systemVersion/buildDetails/@type (string minOccurs=0 maxOccurs=1) attribute specifies the type of build. A value of chk indicates that this is a checked or debug build. A value of fre indicates that this is a retail build. The /system/systemVersion/buildDetails/@official (string minOccurs=0 maxOccurs 1) attribute indicates that the build was produced by an official build process (value of yes), or an unofficial process (value of no).

The /system/roleMap (minOccurs 1 maxOccurs=1) element encapsulates all the elements that make up a roleMap, which include document class relative roleTemplate, priority, name, method, and per-method scope. An individual roleTemplate defines the maximum scope of information, and the allowable methods used to access that information for each request mapped into the template. The /system/roleMap/(changeNumber (minOccurs=0 maxOccurs 1) changeNumber attribute is designed to facilitate caching of the element and its descendants. This attribute is assigned to this element by the .NET My Services system. The attribute is read-only to applications. Attempts to write this attribute are silently ignored. The /system/roleMap/@lid (minOccurs=0 maxOccurs=1) attribute is a globally unique ID assigned to this element by NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The/system/roleMap/@creator (string minOccurs=0 maxOccurs=1) attribute identifies the creator in terms of userId, appId, and platformId of the node. The /system/roleMap/scope (minOccurs=0 maxOccurs=unbounded) element defines a scope which may be referred to by roles within this roleMap to indicate what portions of the document are visible to this role for the specified method.

The /system/roleMap/scope/@id (minOccurs=0 maxOccurs=1) attribute is a globally unique ID assigned to this element by .NET My Services. Normally, NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The/system/roleMap/scope/name (string minOccurs=0 maxOccurs=unbounded) node includes the /system/roleMap/scope/name/@xml:lang (minOccurs 1 maxOccurs=1) required attribute, which is used to specify an ISO 639 language code or an ISO 3166 country code as described in RFC 1766. The value of this attribute indicates the language type of the content within this element. The /system/roleMap/scope/name/@dir (string minOccurs=0 maxOccurs=1) optional attribute specifies the default layout direction for the localized string. Valid values are rt1 (right to left), and Itr (left to right).

The /system/roleMap/scope/shape (minOccurs=1 maxOccurs 1) comprises a shape that defines the node set that is visible through the document when operating through this shape element. The /system/roleMap/scope/shape/@(base (string minOccurs=0 maxOccurs=1) attribute specifies the initial set of nodes visible through the shape. A value of t indicates that the shape is initialized to include all possible nodes relative to the shape that is currently in effect. For instance, each role defines a scope containing a shape. When defining a shape for a role, the value t indicates all possible nodes available in the specified document for this role. When defining a shape in an ACL entry, a value of t means all of the nodes visible in the shape for the computed role. When using a shape in a data language (e.g., query, insert, replace and so on) operation, a value of t indicates all of the possible nodes selected by the data language operation (relative to the ACL shape which itself is relative to the role's shape). The value nil indicates the opposite of t, which is the empty node set. Nodes from this set may then be included into the shape.

The /system/roleMap/scope/shape/include (minOccurs=0 maxOccurs=unbounded) element specifies the set of nodes that should be included into the shape relative to the possible set of nodes indicated by the base attribute. The /system/roleMap/scope/shape/include/@select (string minOccurs=0 maxOccurs=1) item specifies an XPATH expression that selects a set of nodes relative to the externally established context. The expression can never travel outside the node-set established by this externally established current context. The expression may match zero or more nodes, and the operation manipulates all selected nodes. The minOccurs and maxOccurs attributes are optional and place restrictions and limitations on the number of nodes selected.

The /system/roleMap/scope/shape/exclude (minOccurs=0 maxOccurs=unbounded) element specifies the set of nodes that should be excluded from the shape relative to the possible set of nodes indicated by the base attribute. The /system/roleMap/scope/shape/exclude/@select (string minOccurs=0 maxOccurs=1) item specifies an XPATH expression that selects a set of nodes relative to the externally established context. The expression can never travel outside the node-set established by this externally established current context. The expression may match zero (0) or more nodes, and the operation manipulates all selected nodes. The minOccurs and maxOccurs attributes are optional and place restrictions and limitations on the number of nodes selected. The /system/roleMap/roleTemplate (minOccurs=0 maxOccurs=unbounded) element encapsulates the definition of a role. The attribute set for this element includes the document class that this roleTemplate refers to, the name of the roleTemplate, and the priority of the roleTemplate.

The /system/roleMap/roleTemplate/@name (string minOccurs=0 maxOccurs=1) element specifies the name of the role. The /system/roleMap/roleTemplate/@priority (int minOccurs=0 maxOccurs=1) element specifies the priority of the roleTemplate which is used to select that actual roleTemplate when the role evaluation determines that the subject maps to multiple roleTemplates.

The /system/roleMap/roleTemplate/fullDescription (string minOccurs=0 maxOccurs=1) element contains a description of this role template which specifies the capabilities a caller will have when accessing information through this role. The /system/roleMap/roleTemplate/fullDescription/@xml:lang (minOccurs=1 maxOccurs 1) required attribute is used to specify an ISO 639 language code or an ISO 3166 country code as described in RFC 1766. The value of this attribute indicates the language type of the content within this element. The /system/roleMap/roleTemplate/fullDescription/@(dir (string minOccurs=0 maxOccurs=1) optional attribute specifies the default layout direction for the localized string. Valid values are rtl (right to left), and Itr (left to right).

The/system/roleMap/roleTemplate/method (minOccurs=0 maxOccurs=unbounded) element specifies the methods available within this roleTemplate by name, and by scope. When a subject maps to a roleTemplate, the method in the request must match one of these elements for the message to continue to flow. If the method exists, the data available to the method is a function of the scope referenced by this method combined with an optional scope referenced by the role defined in the roleList.

The /system/roleMap/roleTemplate/method/@name (string minOccurs=0 maxOccurs=1) element specifies the name of the method. The /system/roleMap/roleTemplate/method/@scopeRef (string minOccurs=0 maxOccurs=1) attribute specifies the scope within this document that is in effect for this method. The /system/methodMap (minOccurs=1 maxOccurs=1) element defines the methodMap. While in most cases, the roleMap section contains a definitive list of methods, these methods are likely to be scattered about the roleMap in various templates. This section contains the definitive non-duplicated list of methods available within the service.

The /system/methodMap/@(changeNumber (minOccurs=0 maxOccurs=1) changeNumber attribute is designed to facilitate caching of the element and its descendants. This attribute is assigned to this element by the NET My Services system. The attribute is read-only to applications. Attempts to write this attribute are silently ignored.

The/system/methodMap/@id (minOccurs=0 maxOccurs=1) attribute is a globally unique ID assigned to this element by .NET My Services. Normally, NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/methodMap/(creator (string minOccurs=0 maxOccurs 1) attribute identifies the creator in terms of userId, appId, and platformId of the node.

The /system/methodMap/method (minOccurs=0 maxOccurs=unbounded) element defines a method that is available within this service. The /system/methodMap/method/@name (string minOccurs=0 maxOccurs=1) attribute specifies the name of a method available within the service. The /system/methodMap/method/{any} (minOccurs=0 maxOccurs=unbounded) provides for extensibility. The /system/schemaMap (minOccurs=1 maxOccurs=1) element defines the various schema's that define the data structures and shape of information managed by this service. Each schema is defined by its namespace URI, its location, and a preferred namespace alias.

The /system/schemaMap/@changeNumber (minOccurs=0 maxOccurs 1) changeNumber attribute is designed to facilitate caching of the element and its descendants. This attribute is assigned to this element by the .NET My Services system. The attribute is read-only to applications. Attempts to write this attribute are silently ignored.

The/system/schemaMap/@id (minOccurs=0 maxOccurs=1) attribute is a globally unique ID assigned to this element by .NET My Services. Normally, NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/schemaMap/@creator (string minOccurs=0 maxOccurs1) attribute identifies the creator in terms of userId, appId, and platformId of the node. The /system/schemaMap/schema (minOccurs=0 maxOccurs=unbounded) element defines a schema which defines data-structures and the shape of information managed by this service. Multiple schema elements exist for each service, once for each logical grouping of information exposed by the service. The /system/schemaMap/schema/@namespace (anyURI minOccurs=0 maxOccurs=1) attribute specifies the namespace URI of this schema. The /system/schemaMap/schema/@schemaLocation (anyURI minOccurs=0 maxOccurs 1) attribute specifies the location (in the form of a URI) of the resource containing schema. When a schema is reachable through a variety of URIs, one schema element will exist for each location.

The /system/schemaMap/schema/@alias (string minOccurs=0 maxOccurs=1) attribute specifies the preferred alias that should be used if possible when manipulating information covered by this schema in the context of this service. The/system/schemaMap/schema/{any} (minOccurs=0 maxOccurs=unbounded) provides for extensibility. The /system/wsdIMap (minOccurs=1 maxOccurs=1) element defines the wsdlMap for this service. This map includes the location of WSDL documents, DISCO documents, and WSIL documents for this web service. These documents are used by applications to understand the format of messages that may be sent to the various services. The /system/wsdlMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/wsdIMap/@id (minOccurs=0 maxOccurs=1) attribute is a globally unique ID assigned to this element by NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/wsdlMap/@creator (string minOccurs=0 maxOccurs=1) attribute identifies the creator in terms of userId, appId, and platformId of the node.

The /system/wsdIMap/wsdl (minOccurs=0 maxOccurs=unbounded) element is used to specify the location of a WSDL file for this service. Multiple entries may exist pointing to the same file hosted in multiple locations, or to variations on the content within the WSDL files.

The /system/wsdlMap/wsdl/@wsdlLocation (anyURI minOccurs=0 maxOccurs=1) attribute is a URI that specifies the location of the WSDL file. The /system/wsdIMap/wsdl/{any} (minOccurs=0 maxOccurs=unbounded) provides for extensibility.

The /system/wsdIMap/disco (minOccurs=0 maxOccurs=unbounded) element is used to specify the location of a DISCO (web-services discovery) file for this service. Multiple entries may exist pointing to the same file hosted in multiple locations, or to variations on the content within the DISCO files. The /system/wsdlMap/disco/@discoLocation (anyURI minOccurs=0 maxOccurs=1) attribute is a URI that specifies the location of the DISCO file. The /system/wsdIMap/disco/{any} (minOccurs=0 maxOccurs=unbounded) provides extensibility. The /system/wsdIMap/wsil (minOccurs=0 maxOccurs=unbounded) element is used to specify the location of a WSIL file for this service. Multiple entries may exist pointing to the same file hosted in multiple locations, or to variations on the content within the WSIL files. The /system/wsdIMap/wsil/@wsilLocation (anyURI minOccurs=0 maxOccurs=1) attribute is a URI that specifies the location of the WSIL file. The /system/wsdlMap/wsil/{any} (minOccurs=0 maxOccurs=unbounded) provides extensibility.

As can be seen from the foregoing detailed description, there is provided a schema-based notification service that allows notifications to be sent from senders to recipients based on identities and corresponding roles with respect to the data. The schema-based notification service provides notification data independent of the application program and device, and in a centrally-accessible location such as the Internet or an intranet. The schema-based notification service is extensible to handle extended notification information.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a method comprising:
providing a notification schema, the notification schema having notification-related fields arranged into a content document with defined structures for the fields;
formatting notification data associated with an identity into a notification content document based on the notification schema; and
sending the notification content document to a recipient associated with the identity.

2. The method of claim 1 further comprising, receiving the notification content document from a notification service and interpreting the content in accordance with the schema.

3. The method of claim 5 wherein the schema includes at least one defined field for extending the schema.

4. A computer-readable medium having computer-executable instructions for performing the method of claim 1.

5. A computer-readable medium having stored thereon a data structure, comprising:
a first set of data describing a notification;
a second set of data corresponding to content of the notification; and
wherein the first and second sets of data are regularized according to a schema by a notification service such that a recipient of the data structure interprets the data according to the schema.

6. The data structure of claim 5 wherein the first set of data includes data corresponding to a source of the notification.

7. The data structure of claim 5 wherein the first set of data includes data corresponding to at least one time relevant to the notification.

8. The data structure of claim 7 wherein the data corresponding to the at least one time comprises a creation time.

9. The data structure of claim 7 wherein the data corresponding to the at least one time comprises a receiving time.

10. The data structure of claim 5 wherein the first set of data includes subscription-related data corresponding to a source of the notification.

11. The data structure of claim 5 wherein the first set of data includes data corresponding to authorization for accessing the notification.

12. The data structure of claim 5 wherein the first set of data includes data corresponding to a transmission history of the notification.

13. The data structure of claim 5 wherein the first set of data includes data corresponding to a confirmation requirement.

14. The data structure of claim 5 wherein the first set of data includes data corresponding to at least one action to take with respect to at least one condition associated with the notification.

15. The data structure of claim 14 wherein an action comprises rerouting the notification upon a failure condition.

16. The data structure of claim 14 wherein an action comprises journaling the notification upon a failure condition.

17. The data structure of claim 8 wherein the second set of data includes data describing the content.

18. The data structure of claim 8 wherein the second set of data includes data corresponding to visible information.

19. The data structure of claim 8 wherein the second set of data includes data corresponding to audible information.

20. The data structure of claim 8 wherein the second set of data includes data corresponding to recipient device information.

21. The data structure of claim 20 wherein the recipient device information includes data corresponding to bandwidth information for connecting to or from the device.

22. The data structure of claim 20 wherein the recipient device information includes data corresponding to media rendering requirements.

23. The data structure of claim 20 wherein the recipient device information includes data corresponding to user interaction requirements.

24. The data structure of claim 20 wherein the recipient device information includes data corresponding to device input capabilities.

25. The data structure of claim 20 wherein the recipient device information includes data corresponding to backchannel requirements.

26. The data structure of claim 20 wherein the recipient device information includes data corresponding to relay requirements.

27. The data structure of claim 20 wherein the recipient device information includes data corresponding to device context status

28. The data structure of claim 8 wherein the second set of data includes data corresponding to delivery routing information.

29. The data structure of claim 8 wherein the second set of data includes data corresponding to conditions for delivering the notification to at least one endpoint device.

30. The data structure of claim 8 wherein the second set of data includes data corresponding to timing information for delivering the notification.

31. The data structure of claim 8 wherein the second set of data includes data corresponding to device policy data.

32. The data structure of claim 8 wherein the second set of data includes data corresponding to an urgency of the notification.

33. The data structure of claim 8 wherein the second set of data includes data corresponding to a volatility of the notification.

34. The data structure of claim 8 wherein the first set of data includes at least one defined field for extending the schema.

35. The data structure of claim 8 wherein the second set of data includes at least one defined field for extending the schema.

36. In a computer network including a sender that sends an alert to at least one user agent, a system comprising:
an alerts service that receives the alert from the sender, the alert formatted in accordance with an alerts schema;
a stream fork; and
a connection fork, the stream fork configured to send the alert as at least one stream to the connection fork, the connection fork routing the alert to the at least one user agent.

37. The system of claim 36 wherein each user agent provides a connection that communicates with the alerts service to indicate which of a set of alerts its corresponding user agent requests routing thereto.

38. The system of claim 36 wherein the stream fork includes a mechanism that filters the alert.

39. The system of claim 36 wherein the stream fork includes a mechanism that persists the alert.

40. The system of claim 36 wherein the stream fork includes a mechanism that routes the alert.

41. The system of claim 36 wherein the stream fork implements a stream to select, process and/or route alerts.

42. The system of claim 41 wherein the stream comprises a simple stream that selects a set of alerts and routes them to any connection associated with a user agent.

43. The system of claim 41 wherein the stream comprises a buffering stream that selects a subset of alerts and buffers them for a period of time.

44. The system of claim 41 wherein the stream comprises a privacy stream that selects and filters a subset of alerts according to a set of privacy or safety rules.

45. The system of claim 41 wherein the stream comprises a routing stream that selects a subset of alerts and changes their routing to control which succeeding streams or connections will process the alert.

46. The system of claim 41 wherein the stream comprises an external stream that delegates the actual stream algorithm and state to an object external to the alerts service.
